(19) United States
(12) Patent Application Publication
(10) Pub. No.: US 2024/0080696 A1
(43) Pub. Date: Mar. 7, 2024

(54) METHOD AND APPARATUS FOR TRANSMITTING AND RECEIVING PAGING

(71) Applicant: Samsung Electronics Co., Ltd., Suwon-si, Gyeonggi-do (KR)

(72) Inventors: Anil AGIWAL, Suwon-si (KR); Soenghun KIM, Suwon-si (KR)

(21) Appl. No.: 18/268,473

(22) PCT Filed: Dec. 23, 2021
(86) PCT No.: PCT/KR2021/019746

§ 371 Date: Jun. 20, 2023

(30) Foreign Application Priority Data
Dec. 23, 2020 (KR) 10-2020-0181793

(51) Int. Cl. H04W 24/10; H04W 72/044

(52) U.S. Cl. CPC H04W 24/10; H04W 72/046

(57) ABSTRACT

The present application provides a method performed by a user equipment (UE) which supports cross slot scheduling for paging, the method comprising: transmitting, to a first base station, information regarding capability of the UE to support cross slot scheduling for paging; receiving, from a second base station, a message including information indicating that the base station supports cross slot scheduling for paging; monitoring, based on whether supporting cross slot scheduling for paging, a PDCCH addressed to a first RNTI for paging or both the PDCCH addressed to the first RNTI for paging and a PDCCH addressed to a second RNTI for paging; detecting the PDCCH addressed to the first RNTI for paging or the PDCCH addressed to the second RNTI for paging; and receiving and buffering, based on whether supporting cross slot scheduling for paging, a PDSCH while decoding the detected PDCCH.

### TECHNICAL FIELD

The present disclosure relates generally to wireless communication systems, more specifically, the present disclosure relates to method, apparatus and/or systems for transmitting and receiving paging.

### BACKGROUND ART

To meet the demand for wireless data traffic having increased since deployment of 4th generation (4G) communication systems, efforts have been made to develop an improved 5th generation (5G) or pre-5G communication system. The 5G or pre-5G communication system is also called a ‘beyond 4G network’ or a ‘post long term evolution (LTE) system’. The 5G communication system is considered to be implemented in higher frequency (mmWave) bands, e.g., 60 GHz bands, so as to accomplish higher data rates. To decrease propagation loss of the radio waves and increase the transmission distance, beamforming, massive multiple-input multiple-output (MIMO), full dimensional MIMO (FD-MIMO), array antenna, analog beamforming, and large scale antenna techniques are discussed with respect to 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like. In the 5G system, hybrid frequency shift keying (FSK) and Feher's quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, MTC, and M2M communication may be implemented by beamforming, MIMO, and array antennas. Application of a cloud RAN as the above-described big data processing technology may also be considered to be as an example of convergence between the 5G technology and the IoT technology.

As described above, various services can be provided according to the development of a wireless communication system, and thus a method for easily providing such services is required. Especially, a method and apparatus for minimizing UE power consumption in paging is required.

### DISCLOSURE OF INVENTION

### Solution to Problem

The present application provides a method performed by a user equipment (UE) which supports cross slot scheduling for paging, the method comprising: transmitting, to a first base station, information regarding capability of the UE to support cross slot scheduling for paging; receiving, from a second base station, a message including information indicating that the second base station supports cross slot scheduling for paging; monitoring, based on whether supporting cross slot scheduling for paging, a physical downlink control channel (PDCCH) addressed to a first radio network temporary identifier (RNTI) for paging or both the PDCCH addressed to the first RNTI for paging and a PDCCH addressed to a second RNTI for paging; detecting the PDCCH addressed to the first RNTI for paging or the PDCCH addressed to the second RNTI for paging; and receiving and buffering, based on whether supporting cross slot scheduling for paging, a physical downlink shared channel (PDSCH) while decoding the detected PDCCH.

The present application also provides a method performed by a base station which supports cross slot scheduling for paging, the method comprising: transmitting, to a user equipment (UE), a message including information indicating that the base station supports cross slot scheduling for paging; and transmitting, based on whether the UE supports cross slot scheduling for paging, one of a PDCCH addressed to a first RNTI for paging or a PDCCH addressed to a second RNTI for paging.

The present application also provides a user equipment (UE) which supports cross slot scheduling for paging, the UE comprising: a transceiver; and at least one processor coupled to the transceiver and configured to: transmit, to a first base station, information regarding capability of the UE to support cross slot scheduling for paging; receive, from a second base station, a message including information indicating that the second base station supports cross slot scheduling for paging; monitor, based on whether supporting cross slot scheduling for paging, a physical downlink control channel (PDCCH) addressed to a first radio network temporary identifier (RNTI) for paging or both the PDCCH addressed to the first RNTI for paging and a PDCCH addressed to a second RNTI for paging; detect the PDCCH addressed to the first RNTI for paging or the PDCCH addressed to the second RNTI for paging; and receive and buffering, based on whether supporting cross slot scheduling for paging, a physical downlink shared channel (PDSCH) while decoding the detected PDCCH.

The present application also provides a base station which supports cross slot scheduling for paging, the base station comprising: a transceiver; and at least one processor coupled to the transceiver and configured to: transmit, to a user equipment (UE), a message including information indicating that the base station supports cross slot scheduling for paging; and transmit, based on whether the UE supports cross slot scheduling for paging, one of a PDCCH addressed to a first RNTI for paging or a PDCCH addressed to a second RNTI for paging.

### BRIEF DESCRIPTION OF DRAWINGS

FIG. 1 illustrates an example of paging early indication based approach.

FIG. 2 illustrates an example of paging message reception.

FIG. 3 illustrates another example of paging message reception.

FIG. 4a illustrates a flowchart of an operation performed by gNB for paging according to embodiments of the present disclosure.

FIG. 4b illustrates a flowchart of an operation performed by gNB for paging according to embodiments of the present disclosure.

FIG. 5a illustrates a flowchart of an operation performed by UE for paging according to embodiments of the present disclosure.

FIG. 5b illustrates a flowchart of an operation performed by UE for paging according to embodiments of the present disclosure.

FIG. 5c illustrates a flowchart of an operation performed by UE for paging according to embodiments of the present disclosure.

FIG. 6a illustrates a flowchart of an operation performed by gNB for paging according to embodiments of the present disclosure.

FIG. 6b illustrates a flowchart of an operation performed by gNB for paging according to embodiments of the present disclosure.

FIG. 7a illustrates a flowchart of an operation performed by UE for paging according to embodiments of the present disclosure.

FIG. 7b illustrates a flowchart of an operation performed by UE for paging according to embodiments of the present disclosure.

FIG. 7c illustrates a flowchart of an operation performed by UE for paging according to embodiments of the present disclosure.

FIG. 8a illustrates a flowchart of an operation performed by gNB for paging according to embodiments of the present disclosure.

FIG. 8b illustrates a flowchart of an operation performed by gNB for paging according to embodiments of the present disclosure.

FIG. 8c illustrates a flowchart of an operation performed by gNB for paging according to embodiments of the present disclosure.

FIG. 9a illustrates a flowchart of an operation performed by UE for paging according to embodiments of the present disclosure.

FIG. 9b illustrates a flowchart of an operation performed by UE for paging according to embodiments of the present disclosure.

FIG. 10a illustrates a flowchart of an operation performed by gNB for paging according to embodiments of the present disclosure.

FIG. 10b illustrates a flowchart of an operation performed by gNB for paging according to embodiments of the present disclosure.

FIG. 10c illustrates a flowchart of an operation performed by gNB for paging according to embodiments of the present disclosure.

FIG. 11a illustrates a flowchart of an operation performed by UE for paging according to embodiments of the present disclosure.

FIG. 11b illustrates a flowchart of an operation performed by UE for paging according to embodiments of the present disclosure.

FIG. 11c illustrates a flowchart of an operation performed by UE for paging according to embodiments of the present disclosure.

FIG. 12 illustrates a flowchart of an operation performed by UE for paging according to embodiments of the present disclosure.

FIG. 13 illustrates a flowchart of an operation performed by a base station for paging according to embodiments of the present disclosure.

FIG. 14 is a diagram illustrating a UE according to an embodiment of the present disclosure.

FIG. 15 is a diagram illustrating a Base station according to an embodiment of the present disclosure.

### MODE FOR THE INVENTION

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Throughout the disclosure, the expression “at least one of a, b or c” indicates only a, only b, only c, both a and b, both a and c, both b and c, all of a, b, and c, or variations thereof. Throughout the specification, a layer (or a layer apparatus) may also be referred to as an entity. Hereinafter, operation principles of the disclosure will be described in detail with reference to accompanying drawings. In the following descriptions, well-known functions or configurations are not described in detail because they would obscure the disclosure with unnecessary details. The terms used in the specification are defined in consideration of functions used in the disclosure, and can be changed according to the intent or commonly used methods of users or operators. Accordingly, definitions of the terms are understood based on the entire descriptions of the present specification.

For the same reasons, in the drawings, some elements may be exaggerated, omitted, or roughly illustrated. Also, a size of each element does not exactly correspond to an actual size of each element. In each drawing, elements that are the same or are in correspondence are rendered the same reference numeral.

Advantages and features of the disclosure and methods of accomplishing the same may be understood more readily by reference to the following detailed descriptions of embodiments and accompanying drawings of the disclosure. The disclosure may, however, be embodied in many different forms and should not be construed as being limited to the embodiments set forth herein; rather, these embodiments of the disclosure are provided so that this disclosure will be thorough and complete, and will fully convey the concept of the disclosure to one of ordinary skill in the art. Therefore, the scope of the disclosure is defined by the appended claims. Throughout the specification, like reference numerals refer to like elements. It will be understood that blocks in flowcharts or combinations of the flowcharts may be performed by computer program instructions. Because these computer program instructions may be loaded into a processor of a general-purpose computer, a special-purpose computer, or another programmable data processing apparatus, the instructions, which are performed by a processor of a computer or another programmable data processing apparatus, create units for performing functions described in the flowchart block(s).

The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufactured items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It is also noted that, in some alternative implementations, functions mentioned in blocks may occur out of order. For example, two consecutive blocks may also be executed simultaneously or in reverse order depending on functions corresponding thereto.

As used herein, the term “unit” denotes a software element or a hardware element such as a field-programmable gate array (FPGA) or an application-specific integrated circuit (ASIC), and performs a certain function. However, the term “unit” is not limited to software or hardware. The “unit” may be formed so as to be in an addressable storage medium, or may be formed so as to operate one or more processors. Thus, for example, the term “unit” may include elements (e.g., software elements, object-oriented software elements, class elements, and task elements), processes, functions, attributes, procedures, subroutines, segments of program code, drivers, firmware, micro-codes, circuits, data, a database, data structures, tables, arrays, or variables.

Functions provided by the elements and “units” may be combined into the smaller number of elements and “units”, or may be divided into additional elements and “units”. Furthermore, the elements and “units” may be embodied to reproduce one or more central processing units (CPUs) in a device or security multimedia card. Also, in an embodiment of the disclosure, the “unit” may include at least one processor. In the following descriptions of the disclosure, well-known functions or configurations are not described in detail because they would obscure the disclosure with unnecessary details.

Hereinafter, for convenience of explanation, the disclosure uses terms and names defined in the 3rd generation partnership project long term evolution (3GPP LTE) standards. However, the disclosure is not limited to the terms and names, and may also be applied to systems following other standards.

In the disclosure, an evolved node B (eNB) may be interchangeably used with a next-generation node B (gNB) for convenience of explanation. That is, a base station (BS) described by an eNB may represent a gNB. In the following descriptions, the term “base station” refers to an entity for allocating resources to a user equipment (UE) and may be used interchangeably with at least one of a gNode B, an eNode B, a node B, a base station (BS), a radio access unit, a base station controller (BSC), or a node over a network. The term “terminal” may be used interchangeably with a user equipment (UE), a mobile station (MS), a cellular phone, a smartphone, a computer, or a multimedia system capable of performing communication functions. However, the disclosure is not limited to the aforementioned examples. In particular, the disclosure is applicable to 3GPP new radio (NR) (or 5th generation (5G)) mobile communication standards. In the following description, the term eNB may be interchangeably used with the term gNB for convenience of explanation. That is, a base station explained as an eNB may also indicate a gNB. The term UE may also indicate a mobile phone, NB-IoT devices, sensors, and other wireless communication devices.

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In the recent years several broadband wireless technologies have been developed to meet the growing number of broadband subscribers and to provide more and better applications and services. The second generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So fifth generation wireless communication system (also referred as next generation radio or NR) is being developed to meet the growing demand for high speed data services, support ultra-reliability and low latency applications.

The fifth generation wireless communication system supports not only lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive Multiple-Input Multiple-Output (MIMO), Full Dimensional MIMO (FD-MIMO), array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve the UEs having quite different capabilities depending on the use case and market segment the UE cater service to the end customer. A few examples of use cases the fifth generation wireless communication system wireless system is expected to address are enhanced Mobile Broadband (eMBB), massive Machine Type Communication (m-MTC), ultra-reliable low latency communication (URLL) etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the Internet of Things (IoT)/Internet of Everything (IoE) envisioning connectivity of billions of devices. The URLL requirements like very low latency, very high reliability and variable mobility so on and so forth address the market segment representing the Industrial automation application, vehicle-to-vehicle/vehicle-to-infrastructure communication foreseen as one of the enabler for autonomous cars.

In the fifth generation wireless communication system operating in higher frequency (mmWave) bands, UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as transmit (TX) beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of receive (RX) beam patterns of different directions. Each of these receive patterns can be also referred as receive (RX) beam.

CA/Multi-connectivity in fifth generation wireless communication system: The fifth generation wireless communication system, supports standalone mode of operation as well dual connectivity (DC). In DC a multiple Rx/Tx UE may be configured to utilise resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in RRC_CONNECTED is configured to utilise radio resources provided by two distinct schedulers, located in two different nodes connected via a non-ideal backhaul and providing either E-UTRA (i.e. if the node is an ng-eNB) or NR access (i.e. if the node is a gNB). In NR for a UE in RRC_CONNECTED not configured with CA/DC there is only one serving cell comprising of the primary cell. For a UE in RRC_CONNECTED configured with CA/DC the term ‘serving cells’ is used to denote the set of cells comprising of the Special Cell(s) and all secondary cells. In NR the term Master Cell Group (MCG) refers to a group of serving cells associated with the Master Node, comprising of the PCell and optionally one or more SCells. In NR the term Secondary Cell Group (SCG) refers to a group of serving cells associated with the Secondary Node, comprising of the PSCell and optionally one or more SCells. In NR PCell (primary cell) refers to a serving cell in MCG, operating on the primary frequency, in which the UE either performs the initial connection establishment procedure or initiates the connection re-establishment procedure. In NR for a UE configured with CA, Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation the term SpCell (i.e. Special Cell) refers to the PCell of the MCG or the PSCell of the SCG, otherwise the term Special Cell refers to the PCell.

PDCCH in fifth generation wireless communication system: In the fifth generation wireless communication system, Physical Downlink Control Channel (PDCCH) is used to schedule DL transmissions on PDSCH and UL transmissions on PUSCH, where the Downlink Control Information (DCI) on PDCCH includes: Downlink assignments containing at least modulation and coding format, resource allocation, and hybrid-ARQ information related to DL-SCH; Uplink scheduling grants containing at least modulation and coding format, resource allocation, and hybrid-ARQ information related to UL-SCH. In addition to scheduling, PDCCH can be used to for: Activation and deactivation of configured PUSCH transmission with configured grant; Activation and deactivation of PDSCH semi-persistent transmission; Notifying one or more UEs of the slot format; Notifying one or more UEs of the PRB(s) and OFDM symbol(s) where the UE may assume no transmission is intended for the UE; Transmission of TPC commands for PUCCH and PUSCH; Transmission of one or more TPC commands for SRS transmissions by one or more UEs; Switching a UE's active bandwidth part; Initiating a random access procedure. A UE monitors a set of PDCCH candidates in the configured monitoring occasions in one or more configured COntrol REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

In fifth generation wireless communication system, a list of search space configurations is signalled by GNB for each configured BWP wherein each search configuration is uniquely identified by a search space identifier. Identifier of search space configuration to be used for specific purpose such as paging reception, SI reception, random access response reception is explicitly signaled by gNB for each configured BWP. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion (s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation (1) below:

(y*(number of slots in a radio frame)+x−Monitoring-offset-PDCCH-slot)mod (Monitoring-periodicity-PDCCH-slot)=0−equation (1)

The starting symbol of a PDCCH monitoring occasion in each slot having PDCCH monitoring occasion is given by Monitoring-symbols-PDCCH-within-slot. The length (in symbols) of a PDCCH monitoring occasion is given in the CORESET associated with the search space. Search space configuration includes the identifier of CORESET configuration associated with it. A list of CORESET configurations are signalled by GNB for each configured BWP of serving cell wherein each CORESET configuration is uniquely identified by a CORESET identifier. CORESET identifier is unique amongst the BWPs of a serving cell. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported SCS is pre-defined in NR. Each CORESET configuration is associated with a list of TCI (Transmission configuration indicator) states. One DL RS ID (SSB or CSI RS) is configured per TCI state. The list of TCI states corresponding to a CORESET configuration is signalled by gNB via RRC signalling. One of the TCI state in TCI state list is activated and indicated to UE by gNB. TCI state indicates the DL TX beam (DL TX beam is QCLed with SSB/CSI RS of TCI state) used by GNB for transmission of PDCCH in the PDCCH monitoring occasions of a search space.

BWP operation in fifth generation wireless communication system: In fifth generation wireless communication system bandwidth adaptation (BA) is supported. With BA, the receive and transmit bandwidth of a UE need not be as large as the bandwidth of the cell and can be adjusted: the width can be ordered to change (e.g. to shrink during period of low activity to save power); the location can move in the frequency domain (e.g. to increase scheduling flexibility); and the subcarrier spacing can be ordered to change (e.g. to allow different services). A subset of the total cell bandwidth of a cell is referred to as a Bandwidth Part (BWP). BA is achieved by configuring RRC connected UE with BWP(s) and telling the UE which of the configured BWPs is currently the active one. When BA is configured, the UE only has to monitor PDCCH on the one active BWP i.e. it does not have to monitor PDCCH on the entire DL frequency of the serving cell. In RRC connected state, UE is configured with one or more DL and UL BWPs, for each configured Serving Cell (i.e. PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

Random access in fifth generation wireless communication system: In the 5G wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in RRC CONNECTED state. Several types of random access procedure is supported such as contention based random access, contention free random access and each of these can be one 2 step or 4 step random access.

System information acquisition in fifth generation wireless communication system: In the fifth generation wireless communication system, node B (gNB) or base station in cell broadcasts Synchronization Signal and PBCH block (SSB) consisting of primary and secondary synchronization signals (PSS, SSS) and system information. System information includes common parameters needed to communicate in cell. In the fifth generation wireless communication system (also referred as next generation radio or NR), System Information (SI) is divided into the Master Information Block (MIB) and a number of System Information Blocks (SIBs) where:
the MIB is always transmitted on the BCH with a periodicity of 80 ms and repetitions made within 80 ms and it includes parameters that are needed to acquire SIB1 from the cell.
the SIB1 is transmitted on the DL-SCH with a periodicity of 160 ms and variable transmission repetition. The default transmission repetition periodicity of SIB1 is 20 ms but the actual transmission repetition periodicity is up to network implementation. The scheduling information in SIB1 includes mapping between SIBs and SI messages, periodicity of each SI message and SI window length. The scheduling information in SIB1 includes an indicator for each SI message, which indicates whether the concerned SI message is being broadcasted or not. If at least one SI message is not being broadcasted, SIB1 may include random access resources (PRACH preamble(s) and PRACH resource(s)) for requesting gNB to broadcast one or more SI message(s).
SIBs other than SIB1 are carried in System Information (SI) messages, which are transmitted on the DL-SCH. Only SIBs having the same periodicity can be mapped to the same SI message. Each SI message is transmitted within periodically occurring time domain windows (referred to as SI-windows with same length for all SI messages). Each SI message is associated with a SI-window and the SI-windows of different SI messages do not overlap. That is, within one SI-window only the corresponding SI message is transmitted. Any SIB except SIB1 can be configured to be cell specific or area specific, using an indication in SIB 1. The cell specific SIB is applicable only within a cell that provides the SIB while the area specific SIB is applicable within an area referred to as SI area, which consists of one or several cells and is identified by systemInformationAreaID.

UE acquires SIB1 from the camped or serving cell. UE check the BroadcastStatus bit in SIB1 for SI message which UE needs to acquire. SI request configuration for SUL is signalled by gNB using the IE si-RequestConfigSUL in SIB 1. If the IE si-RequestConfigSUL is not present in SIB1, UE considers that SI request configuration for SUL is not signalled by gNB. SI request configuration for NUL is signalled by gNB using the IE si-RequestConfig in SIB 1. If the IE si-RequestConfig is not present in SIB1, UE considers that SI request configuration for NUL is not signalled by gNB. If SI message which UE needs to acquire is not being broadcasted (i.e. BroadcastStatus bit is set to zero), UE initiates transmission of SI request. The procedure for SI request transmission is as follows:

If SI request configuration is signalled by gNB for SUL, and criteria to select SUL is met (i.e. RSRP derived from SSB measurements of camped or serving cell <rsrp-ThresholdSSB-SUL, where rsrp-ThresholdSSB-SUL is signalled by gNB (e.g. in broadcast signaling such as SIB1)): UE initiate transmission of SI request based on Msg1 based SI request on SUL. In other words, UE initiates Random Access procedure using the PRACH preamble(s) and PRACH resource(s) in SI request configuration of SUL. UE transmits Msg1 (i.e. Random access preamble) and waits for acknowledgement for SI request. Random access resources (PRACH preamble(s) and PRACH occasions(s)) indicated in SI request configuration of SUL is used for Msg1. Msg1 is transmitted on SUL. If acknowledgement for SI request is received, UE monitors the SI window of the requested SI message in one or more SI period(s) of that SI message.

Else if SI request configuration is signalled by gNB for NUL and criteria to select NUL is met (i.e. NUL is selected if SUL is supported in camped or serving cell and RSRP derived from SSB measurements of camped or serving cell >=rsrp-ThresholdSSB-SUL; or NUL is selected if SUL is not supported in serving cell): UE initiate transmission of SI request based on Msg1 based SI request on NUL. In other words, UE initiates Random Access procedure using the PRACH preamble(s) and PRACH resource(s) in SI request configuration of NUL. UE transmits Msg1 (i.e. Random access preamble) and waits for acknowledgement for SI request. Random access resources (PRACH preamble(s) and PRACH occasions(s)) indicated in SI request configuration of NUL is used for Msg1. Msg1 is transmitted on NUL. If acknowledgement for SI request is received, UE monitors the SI window of the requested SI message in one or more SI period(s) of that SI message.

Else UE initiate transmission of SI request based on Msg3 based SI request. In other words, UE initiate transmission of RRCSystemInfoRequest message. UE transmits Msg1 (i.e. Random access preamble) and waits for random access response. Common random access resources (PRACH preamble(s) and PRACH occasions(s)) are used for Msg1. In the UL grant received in random access response, UE transmits RRCSystemInfoRequest message and waits for acknowledgement for SI request (i.e. RRCSystemInfoRequest message). If acknowledgement for SI request (i.e. RRCSystemInfoRequest message) is received, UE monitors the SI window of the requested SI message in one or more SI period(s) of that SI message. Note that if SUL is configured, UL carrier for Msg1 transmission will be selected by UE in similar manner as selected by UE for Msg1 based SI request. SUL is the selected UL carrier, if RSRP derived from SSB measurements of camped or serving cell <rsrp-ThresholdSSB-SUL where rsrp-ThresholdSSB-SUL is signaled by gNB (e.g. in broadcast signalling such as SIB1). NUL is the selected UL carrier, if RSRP derived from SSB measurements of camped or serving cell >=rsrp-ThresholdSSB-SUL where rsrp-ThresholdSSB-SUL is signalled by gNB (e.g. in broadcast signalling such as SIB1).

Paging in fifth generation wireless communication system: In the fifth generation wireless communication system, UE can be in one of the following RRC states: RRC_IDLE, RRC_INACTIVE, and RRC_CONNECTED. The RRC states can further be characterized as follows:

In RRC_IDLE state, a UE specific Discontinuous Reception (DRX) may be configured by upper layers (i.e. NAS). The UE monitors short Messages transmitted with P-RNTI over DCI; Monitors a Paging channel for CN paging using 5G SAE Temporary Mobile Subscriber Identity (5G-S-TMSI); Performs neighboring cell measurements and cell (re-)selection; Acquires system information and can send SI request (if configured).

In RRC_INACTIVE state, a UE specific DRX may be configured by upper layers or by RRC layer; In this state, UE stores the UE Inactive Access Stratum (AS) context. A RAN-based notification area is configured by RRC layer. The UE monitors Short Messages transmitted with P-RNTI over DCI; Monitors a Paging channel for CN paging using 5G-S-TMSI and RAN paging using fullI-RNTI; Performs neighbouring cell measurements and cell (re-)selection; Performs RAN-based notification area updates periodically and when moving outside the configured RAN-based notification area; Acquires system information and can send SI request (if configured)).

In RRC_CONNECTED state, the UE stores the AS context. Unicast data is transmitted/received to/from UE. At lower layers, the UE may be configured with a UE specific DRX. The UE, monitors Short Messages transmitted with P-RNTI over DCI, if configured; Monitors control channels associated with the shared data channel to determine if data is scheduled for it; Provides channel quality and feedback information; Performs neighbouring cell measurements and measurement reporting; Acquires system information.

In the RRC_CONNECTED, network may initiate suspension of the RRC connection by sending RRCRelease with suspend configuration. When the RRC connection is suspended, the UE stores the UE Inactive AS context and any configuration received from the network, and transits to RRC_INACTIVE state. If the UE is configured with SCG, the UE releases the SCG configuration upon initiating a RRC Connection Resume procedure. The RRC message to suspend the RRC connection is integrity protected and ciphered.

The resumption of a suspended RRC connection is initiated by upper layers when the UE needs to transit from RRC_INACTIVE state to RRC_CONNECTED state or by RRC layer to perform a RAN-based Notification Area (RNA) update or by RAN paging from NG-RAN. When the RRC connection is resumed, network configures the UE according to the RRC connection resume procedure based on the stored UE Inactive AS context and any RRC configuration received from the network. The RRC connection resume procedure re-activates AS security and re-establishes Signalling Radio Bearer(s) (SRB(s)) and Data Radio Bearer(s) (DRB(s)). In response to a request to resume the RRC connection, the network may resume the suspended RRC connection and send UE to RRC_CONNECTED, or reject the request to resume and send UE to RRC_INACTIVE (with a wait timer), or directly re-suspend the RRC connection and send UE to RRC_INACTIVE, or directly release the RRC connection and send UE to RRC_IDLE, or instruct the UE to initiate NAS level recovery (in this case the network sends an RRC setup message).

Upon initiating the resume procedure, UE:

apply the default L1 parameter values as specified in corresponding physical layer specifications, except for the parameters for which values are provided in SIB1; apply the default MAC Cell Group configuration; apply the CCCH configuration; start timer T319; apply the timeAlignmentTimerCommon included in SIB1; apply the default SRB1 configuration; set the variable pendingRNA-Update to false; initiate transmission of the RRCResumeRequest message or RRCResumeRequest1; restore the RRC configuration, RoHC state, the stored QoS flow to DRB mapping rules and the K_{gNB} and K_{RRCint} keys from the stored UE Inactive AS context except for the following: masterCellGroup, mrdc-SecondaryCellGroup, if stored; and pdcp-Config; set the resumeMAC-I to the 16 least significant bits of the MAC-I calculated: with the K_{RRCint} key in the UE Inactive AS Context and the previously configured integrity protection algorithm; and with all input bits for COUNT, BEARER and DIRECTION set to binary ones; derive the K_{gNB} key based on the current K_{gNB} key or the NH, using the stored nextHopChainingCount value; derive the K_{RRCenc} key, the K_{RRCint} key, the K_{UPint} key and the K_{UPenc} key; configure lower layers to apply integrity protection for all signaling radio bearers except SRB0 using the configured algorithm and the K_{RRCint} key and K_{UPint} key, i.e., integrity protection shall be applied to all subsequent messages received and sent by the UE; configure lower layers to apply ciphering for all signalling radio bearers except SRB0 and to apply the configured ciphering algorithm, the K_{RRCenc} key and the K_{UPenc} key derived in this subclause, i.e. the ciphering configuration shall be applied to all subsequent messages received and sent by the UE; re-establish PDCP entities for SRB1; resume SRB1; transmit RRCResumeRequest or RRCResumeRequest1.

The 5G or Next Generation Radio Access Network (NG-RAN) based on NR consists of NG-RAN nodes where NG-RAN node is a gNB, providing NR user plane and control plane protocol terminations towards the UE. The gNBs are also connected by means of the NG interfaces to the SGC, more specifically to the AMF (Access and Mobility Management Function) by means of the NG-C interface and to the UPF (User Plane Function) by means of the NG-U interface. In the 5^{th} generation (also referred as NR or New Radio) wireless communication system, the UE may use Discontinuous Reception (DRX) in RRC_IDLE and RRC_INACTIVE state in order to reduce power consumption. In the RRC_IDLE/RRC_INACTIVE state UE wake ups at regular intervals (i.e. every DRX cycle) for short periods to receive paging, to receive SI update notification and to receive emergency notifications. Paging message is transmitted using physical downlink shared channel (PDSCH). Physical downlink common control channel (PDCCH) is addressed to P-RNTI if there is a paging message in PDSCH. P-RNTI is common for all UEs. UE identity (i.e. S-TMSI for RRC_IDLE UE or I-RNTI for RRC_INACTIVE UE) is included in paging message to indicate paging for a specific UE. Paging message may include multiple UE identities to page multiple UEs. Paging message is broadcasted (i.e. PDCCH is masked with P-RNTI) over data channel (i.e. PDCCH). SI update and emergency notifications are included in DCI and PDCCH carrying this DCI is addressed to P-RNTI. In the RRC idle/inactive mode UE monitors one paging occasion (PO) every DRX cycle. In the RRC idle/inactive mode UE monitors PO in initial DL BWP. In RRC connected state UE monitors one or more POs to receive SI update notification and to receive emergency notifications. In RRC connected state, UE can monitor any PO in paging DRX cycle and monitors at least one PO in SI modification period. In the RRC idle/inactive mode UE monitors PO every DRX cycle in its active DL BWP. A PO is a set of ‘S’ PDCCH monitoring occasions for paging, where ‘S’ is the number of transmitted SSBs (i.e. the Synchronization Signal and PBCH block (SSB) consists of primary and secondary synchronization signals (PSS, SSS) and PBCH) in cell. UE first determines the paging frame (PF) and then determines the PO with respect to the determined PF. One PF is a radio frame (10 ms).
The PF for a UE is the radio frame with system frame number ‘SFN’ which satisfies the equation (SFN+PF_offset) mod T=(T div N)*(UE ID mod N).
Index (i_s), indicating the index of the PO is determined by i_s=floor(UE ID/N) mod Ns.
T is DRX cycle of the UE.
In RRC_INACTIVE state, T is determined by the shortest of the UE specific DRX value configured by RRC, UE specific DRX value configured by NAS, and a default DRX value broadcast in system information.
In RRC_IDLE state, T is determined by the shortest of UE specific DRX value configured by NAS, and a default DRX value broadcast in system information. If UE specific DRX is not configured by upper layers (i.e. NAS), the default value is applied.
N: number of total paging frames in T
Ns: number of paging occasions for a PF
PF_offset: offset used for PF determination
UE ID: 5G-S-TMSI mod 1024
Parameters Ns, nAndPagingFrameOffset, and the length of default DRX Cycle are signaled in SIB1. The values of N and PF_offset are derived from the parameter nAnd-PagingFrameOffset. If the UE has no 5G-S-TMSI, for instance when the UE has not yet registered onto the network, the UE shall use as default identity UE ID=0 in the PF and i_s formulas above.
The PDCCH monitoring occasions for paging are determined based on paging search space configuration (paging-SearchSpace) signaled by gNB.
When SearchSpaceId=0 is configured for pagingSearchSpace, the PDCCH monitoring occasions for paging are same as for RMSI. When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.
When SearchSpaceId other than 0 is configured for pagingSearchSpace, the UE monitors the (i_s+1)^{th} PO. The PDCCH monitoring occasions for paging are determined based on paging search space configuration (paging-SearchSpace) signalled by gNB. The PDCCH monitoring occasions for paging which are not overlapping with UL symbols (determined according to tdd-UL-DL-ConfigurationCommon) are sequentially numbered from zero starting from the 1st PDCCH monitoring occasion for paging in the PF. The gNB may signal parameter firstPDCCH-MonitoringOccasionOfPO for each PO corresponding to a PF. When firstPDCCH-MonitoringOccasionOfPO is signalled, the (i_s+1)^{th} PO is a set of ‘S’ consecutive PDCCH monitoring occasions for paging starting from the PDCCH monitoring occasion number indicated by firstPDCCH-MonitoringOccasionOfPO (i.e. the (i_s+1)^{th} value of the firstPDCCH-MonitoringOccasionOfPO parameter). Otherwise, the (i_s+1)th PO is a set of ‘S’ consecutive PDCCH monitoring occasions for paging starting from the (i_s*S)^{th} PDCCH monitoring occasion for paging. ‘S’ is the number of actual transmitted SSBs determined according to parameter ssb-PositionsInBurst signalled in SystemInfonnationBlock1 received from gNB. The parameter firstPDCCH-MonitoringOccasionOfPO is signalled in SIB1 for paging in initial DL BWP. For paging in a DL BWP other than the initial DL BWP, the parameter firstPDCCH-MonitoringOccasionOfPO is signaled in the corresponding BWP configuration.

The PDCCH addressed to P-RNTI carries information according to DCI format 1_0. The following information is transmitted by means of the DCI format 1_0 with CRC scrambled by P-RNTI:
Short Messages Indicator—2 bits according to Table 1.
Short Messages—8 bits according to Table 2. If only the scheduling information for Paging is carried, this bit field is reserved.
Frequency domain resource assignment—┌log₂(N_{RB}^{DL,BWP}(N_{RB}^{DL,BWP}+1)/2)┐ bits. If only the short message is carried, this bit field is reserved.
N_{RB}^{DL,BWP} is the size of CORESET 0
Time domain resource assignment—4 bits as defined in Subclause 5.1.2.1 of [6, TS 38.214]. If only the short message is carried, this bit field is reserved.
VRB-to-PRB mapping—1 bit according to Table 7.3.1.1.2-33 of TS 38.212. If only the short message is carried, this bit field is reserved.
Modulation and coding scheme—5 bits as defined in Subclause 5.1.3 of [6, TS38.214], using Table 5.1.3.1-1 of TS38.214. If only the short message is carried, this bit field is reserved.
TB scaling—2 bits as defined in Subclause 5.1.3.2 of [6, TS38.214]. If only the short message is carried, this bit field is reserved.
Reserved bits—6 bits

Table 1 may define Short Message indicator.

TABLE 1

| Bit field | Short Message indicator |
|---|---|
| 00 | Reserved |
| 01 | Only scheduling information for Paging is present in the DCI |
| 10 | Only short message is present in the DCI |
| 11 | Both scheduling information for Paging and short message are |
| | present in the DCI |

Table 2 defines Short Message. Bit 1 is the most significant bit.

TABLE 2

| Bit | Short Message |
|---|---|
| 1 | SystemInfoModification |
| | If set to 1: indication of a BCCH modification |
| | other than SIB6, SIB7 and SIB8. |
| 2 | etwsAndCmasIndication |
| | If set to 1; indication of an ETWS primary notification |
| | and/or an ETWS secondary notification and/or a CMAS notification. |
| 3-8 | Reserved |

Issue 1:

If PDCCH addressed to P-RNTI is received in slot n, PDSCH for paging message is scheduled in slot n+K0. K0 is indicated in DCI of PDCCH addressed to P-RNTI. K0 can be zero or greater than zero. The default values of K0 for FR1 frequency bands is 0. The default values for K0 for FR2 frequency bands is 0 and 1. The default value means that every UE has to support these values. Since the exact value of K0 used for scheduling paging message is known after receiving and processing the PDCCH addressed to P-RNTI. UE has to receive and buffer PDSCH while it is processing PDCCH addressed to P-RNTI. This leads to unnecessary power consumption in the following cases:
Case 1: PDSCH for paging message is scheduled in a slot different than the slot in which PDCCH is received, K0 in DCI is greater than 0.
Case 2: PDCCH addressed to P-RNTI does not schedule paging message i.e. short message indicator is set to 10 in DCI.

To minimize UE power consumption, gNB can indicate (e.g. in SI) that paging message will always be scheduled in a slot different from slot in which corresponding PDCCH addressed to P-RNTI is received. For example, PDCCH addressed to P-RNTI is transmitted in slot N and scheduled paging message is transmitted in slot N+1 or N+K0 where K0>0. minKoPaging can be signalled in system information or can be pre-defined (K0 indicated in DCI of PDCCH addressed to P-RNTI is >minKo or K0 indicated in DCI of PDCCH addressed to P-RNTI is >=minKo). The issue is how to handle the legacy UEs. Legacy UE may not support K0>0. For example, in FR1, if gNB schedules paging message in slot n+K0 where K0>0, legacy UE may not able to receive the paging message. If gNB schedules paging message in slot n+K0 where K0=0, new UEs which supports cross slot paging may not be able to receive the paging message as they assume that K0>0. So a method for co-existence of legacy and new UEs is needed.

Issue 2:

To minimise UE power consumption, paging message reception based on early paging indication is being studied. FIG. 1 illustrates an example of paging early indication based approach:
UE monitors PDCCH in PMO (PDCCH monitoring occasion) of early paging indication. PMO of early paging indication occurs before the PMO of PO.
UE receives PDCCH in PMO of early paging indication.
If the DCI of received PDCCH indicates that there is paging.
   UE monitors PO to receive scheduling information for paging message
   UE receives paging message according to scheduling information in DCI of PDCCH transmitted in PO
Else
   UE does not monitor PO
SI update/emergency notification can also be included in DCI of early paging indication. So that UE does not have to monitor PO if only SI update/emergency notification is transmitted by gNB.

The issue with this approach is that for paging transmission/reception, multiple DCI for paging are needed. This leads to increased power consumption, signaling overhead, multiple beam sweeping in case of beam formed paging.

Cross Slot Scheduling for Paging

FIG. 2 illustrates an example of paging message reception. PDCCH addressed to P-RNTI is transmitted in slot n. Short message indicator field (2 bits) in DCI is set to ‘01’ or ‘11’ which indicates that DCI includes the scheduling information for paging message. ‘01’ indicates that scheduling information for paging message is included in DCI and short message is not included. ‘11’ indicates that scheduling information for paging message is included in DCI and short message is also included in DCI. Time domain resource assignment field in the DCI indicates K0, where K0>=0. A list of K0 is signalled in system information. Time domain resource assignment field indicates the index of a row in that list. The PDSCH including the paging message is scheduled in slot ‘n+K0’. UE can know the value of K0 after it has received and decoded PDCCH addressed to P-RNTI and processed the fields of DCI. The PDSCH caring paging message can be scheduled in same slot as the PDCCH. So UE has to receive and buffer PDSCH while it is processing PDCCH. This reception and buffering of PDSCH is waste if DCI of PDCCH addressed to P-RNTI indicates paging message scheduled in a slot different from the slot in which PDCCH addressed to P-RNTI is received.

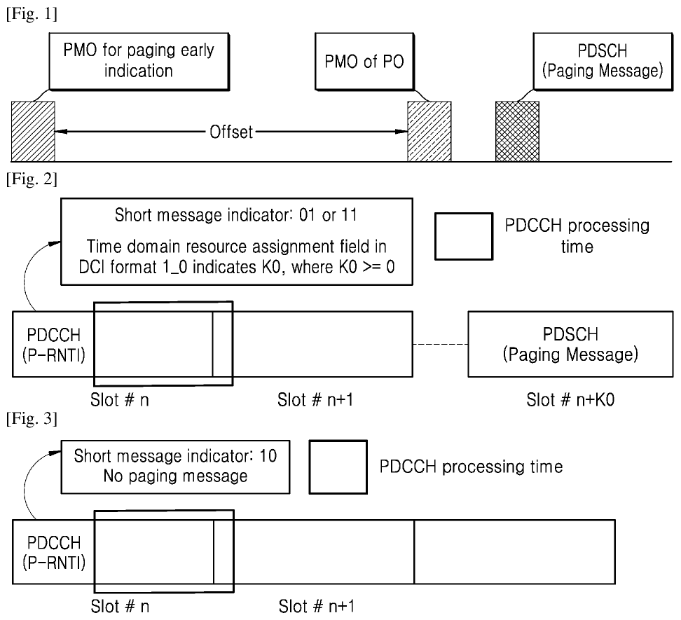

FIG. 3 illustrates another example of paging message reception. PDCCH addressed to P-RNTI is transmitted in slot n. Short message indicator field (2 bits) in DCI is set to ‘10’ which indicates that DCI includes short message and DCI does not include the scheduling information for paging message. UE can know whether paging message is scheduled or not, after it has received and decoded PDCCH addressed to P-RNTI and processed the fields of DCI. So UE has to receive and buffer PDSCH while it is processing PDCCH. This reception and buffering of PDSCH is waste if DCI of PDCCH addressed to P-RNTI indicates paging message is not scheduled.

Embodiment 1-1: In one embodiment of the proposed invention to minimize UE's power consumption operation, transmission and reception of paging may be as follows:

UE which supports cross slot scheduling for paging, may indicate its capability to support cross slot scheduling for paging via UE capability information message to gNB in RRC_CONNECTED. UE may send UE capability information message to gNB in response to UE capability request from gNB. gNB may provide the UE's capabilities to AMF wherein the AMF stores these capabilities.

In case of CN paging, gNB may receive UE's capability to support cross slot scheduling for paging in paging message from AMF

In case of RAN paging, gNB may receive UE's capability to support cross slot scheduling for paging in Core Network assistance information message from AMF

gNB Operation

gNB which supports cross slot scheduling for paging, may broadcast a new parameter i.e. crossSlotSchedulingEnabled in SIB (e.g. SIB1 or SIB 2 or any other SIB). Inclusion of this parameter in SIB is optional. In an embodiment, crossSlotSchedulingEnabled can be included in RRCRelease message wherein the RRCRelease message includes suspend configuration and UE transitions to RRC_INACTIVE state upon receiving the RRCRelease message. In another embodiment, crossSlotSchedulingEnabled can be included in RRCReconfiguration message.

If gNB has signalled crossSlotSchedulingEnabled flag:
For scheduling paging message which includes paging for one or more UEs which supports cross slot scheduling (note that gNB knows whether UE supports cross slot scheduling or not as explained earlier):
   gNB may transmit PDCCH addressed to P-RNTI 1. (P-RNTI 1 can be a reserved RNTI (e.g. FFFD) or can be signalled by gNB in SI or RRC signaling message) Note that value of P-RNTI 1 is different from the value of P-RNTI.
   PDCCH may include scheduling information for paging message
   PDCCH may or may not include Short message
For scheduling paging message which includes paging for one or more UEs which does not support cross slot scheduling
   gNB may transmit PDCCH addressed to P-RNTI (e.g. P-RNTI is FFFE)
   PDCCH may include scheduling information for paging message
   PDCCH may or may not include short message
For scheduling only short message
   gNB may transmit PDCCH addressed to P-RNTI; PDCCH may include Short message

Else (i.e. if gNB has not signalled crossSlotSchedulingEnabled flag)
For scheduling paging message for one or more UEs
   gNB may transmit PDCCH addressed to P-RNTI
   PDCCH may include scheduling information for paging message
   PDCCH may or may not include short message
For scheduling only short message
   gNB may transmit PDCCH addressed to P-RNTI
   PDCCH may include Short message

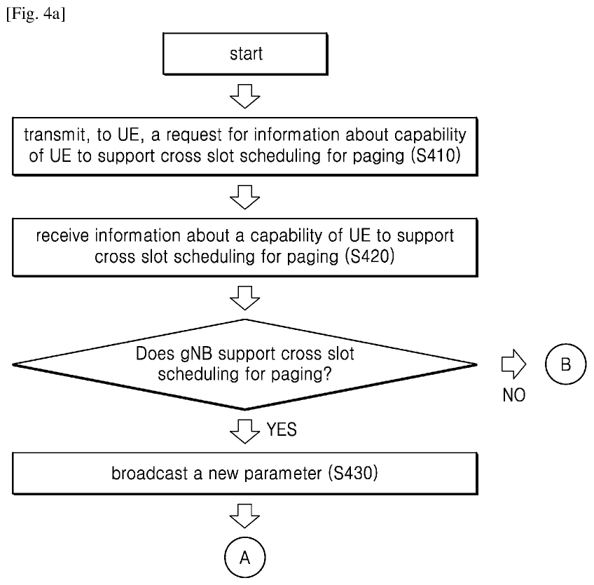

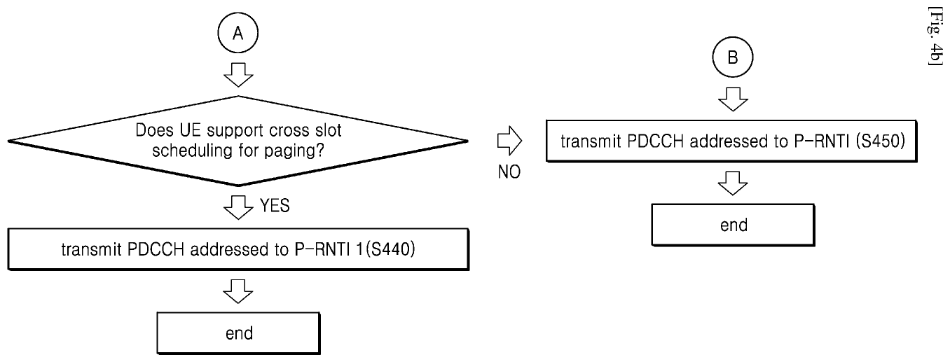

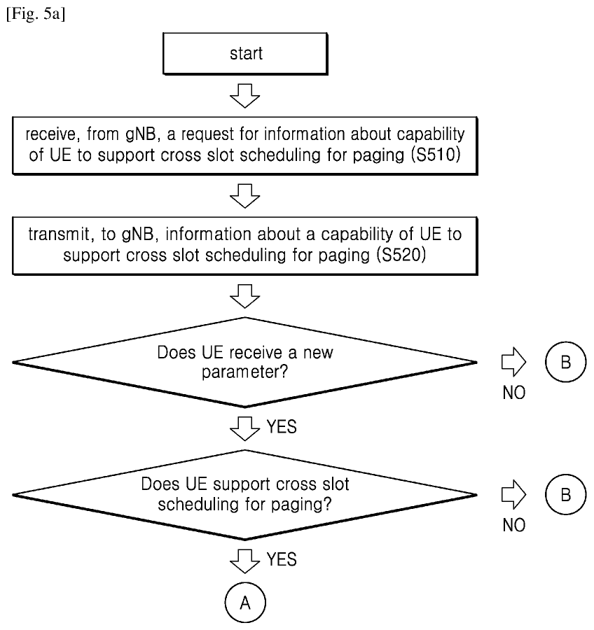

FIGS. 4a and 4b illustrate a flowchart of an operation performed by gNB for paging according to embodiments of the present disclosure.

In step 410, gNB may transmit, to UE, a request for information about capability of UE to support cross slot scheduling for paging. In one embodiment, gNB may receive UE capability information message including information about capability of UE to support cross slot scheduling for paging. Then, gNB may provide information about capability of the UE to support cross slot scheduling for paging to AMF wherein the AMF may store information.

In step 420, gNB may receive information about a capability of UE to support cross slot scheduling for paging. In one embodiment, in case of CN paging, gNB may receive information about capability of UE to support cross slot scheduling for paging in paging message from AMF. In another embodiment, in case of RAN paging, gNB may receive information about capability of UE to support cross slot scheduling for paging in Core Network assistance information message from AMF.

In step 430, in case that gNB supports cross slot scheduling for paging, gNB may broadcast a new parameter (i.e. crossSlotSchedulingEnabled). Inclusion of this parameter in SIB may be optional. In one embodiment, crossSlotSchedulingEnabled may be in SIB (e.g. SIB1 or SIB 2 or any other SIB). In another embodiment, crossSlotSchedulingEnabled may be included in RRCRelease message wherein the RRCRelease message includes suspend configuration and UE transitions to RRC_INACTIVE state upon receiving the RRCRelease message. In the other embodiment, crossSlotSchedulingEnabled may be included in RRCReconfiguration message.

Referring to FIG. 4b, in step 440, in case that UE supports cross slot scheduling for paging, gNB may transmit PDCCH addressed to P-RNTI 1 to schedule paging message. In one embodiment, P-RNTI 1 may be a reserved RNTI (e.g. FFFD). In another embodiment, P-RNTI 1 may be signalled by gNB in SI or RRC signaling message. Note that value of P-RNTI 1 is different from the value of P-RNTI.

In one embodiment, PDCCH may include scheduling information for paging message. In another embodiment, PDCCH may or may not include short message.

In one embodiment, P-RNTI 1 may refer to a first radio network temporary identifier (RNTI) for paging. Also, P-RNTI may refer to a second RNTI for paging.

In step 450, in case that UE does not support cross slot scheduling for paging, gNB may transmit PDCCH addressed to P-RNTI to schedule paging message (e.g. P-RNTI is FFFE). In one embodiment, PDCCH may include scheduling information for paging message. In another embodiment, PDCCH may or may not include short message.

In case that gNB does not support cross slot scheduling for paging, gNB may transmit PDCCH addressed to P-RNTI to schedule paging message. In one embodiment, when gNB does not support cross slot scheduling for paging, gNB may not signal crossSlotSchedulingEnabled flag. Then, gNB may transmit PDCCH including scheduling information for paging message.

Meanwhile, to schedule only short message, gNB may transmit PDCCH addressed to P-RNTI. In one embodiment, PDCCH may include Short message.

UE Operation

UE which supports cross slot scheduling for paging, may indicate its capability to support cross slot scheduling for paging via UE capability information message to gNB in RRC_CONNECTED. UE may send UE capability information message to gNB in response to UE capability request from gNB.

UE may acquire the paging configuration from SI in RRC IDLE/RRC INACTIVE

If gNB has signalled crossSlotSchedulingEnabled flag and UE has indicated that it supports cross slot scheduling capability:
UE may monitor PDCCH addressed to P-RNTI and P-RNTI 1
UE may not buffer PDSCH while processing PDCCH addressed to P-RNTI 1 or UE may not buffer PDSCH while processing PDCCH irrespective of whether PDCCH is addressed to P-RNTI or P-RNTI 1. (as PDCCH addressed to P-RNTI is monitored by UE for short message only)
If PDCCH addressed to P-RNTI 1 schedules paging message, UE may receive PDSCH from the slot ‘n+K0’, where ‘n’ is the slot in which UE receives PDCCH addressed to P-RNTI 1.

Else
UE may monitor PDCCH addressed to P-RNTI
UE may buffer PDSCH while processing PDCCH
The buffered information may be discarded if upon processing the received PDCCH UE determines that paging message is not scheduled or is scheduled at ‘n+K0’ where K0 is greater than PDCCH processing time.

In an embodiment, if UE receives crossSlotSchedulingEnabled in RRCRelease message as well as in system information, UE may apply crossSlotSchedulingEnabled received in RRCRelease in the above operation. In an embodiment, if UE receives crossSlotSchedulingEnabled in RRCRelease message as well as in system information, UE may apply crossSlotSchedulingEnabled received in RRCRelease in the above operation if the UE is in RRC_INACTIVE.

In an embodiment, if UE receives crossSlotSchedulingEnabled in RRCRelease message as well as in system information, UE may apply crossSlotSchedulingEnabled in RRCRelease in RRC_INACTIVE and UE may apply crossSlotSchedulingEnabled in system information in RRC_IDLE. If crossSlotSchedulingEnabled is not received in RRCRelease message, UE may apply crossSlotSchedulingEnabled received in system information in RRC_INACTIVE as well.

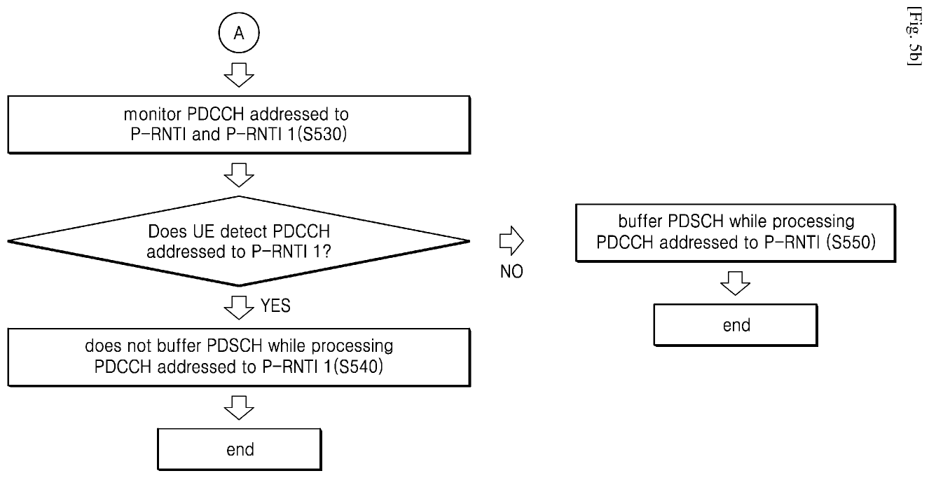

FIGS. 5a, 5b and 5c illustrate a flowchart of an operation performed by UE for paging according to embodiments of the present disclosure.

In step 510, UE may receive from gNB, a request for information about capability of UE to support cross slot scheduling for paging.

In step 520, UE may transmit, to gNB, information about a capability of UE to support cross slot scheduling for paging. In one embodiment, UE may send UE capability information message to gNB in response to the request from gNB. For example, UE which supports cross slot scheduling for paging, may indicate its capability to support cross slot scheduling for paging via UE capability information message to gNB in RRC_CONNECTED.

Referring to FIG. 5b, in step 530, in case that UE receives a new parameter (i.e. crossSlotSchedulingEnabled) and UE supports cross slot scheduling for paging and UE supports cross slot scheduling for paging, UE may monitor PDCCH addressed to P-RNTI and P-RNTI 1. In step 540, in case that UE detects PDCCH addressed to P-RNTI 1, UE may not buffer PDSCH while processing PDCCH addressed to P-RNTI 1. In one embodiment, if PDCCH addressed to P-RNTI 1 schedules paging message, UE may receive PDSCH from the slot ‘n+K0’, wherein ‘n’ is the slot in which UE receives PDCCH addressed to P-RNTI 1.

In one embodiment, P-RNTI 1 may refer to a first radio network temporary identifier (RNTI) for paging. Also, P-RNTI may refer to a second RNTI for paging.

In step 550, in case that UE detects PDCCH addressed to P-RNTI, UE may buffer PDSCH while processing PDCCH addressed to P-RNTI. In one embodiment, the buffered information may be discarded if upon processing the received PDCCH UE determines that paging message is not scheduled or is scheduled at ‘n+K0’ where K0 is greater than PDCCH processing time. In an embodiment at step 550, in case that UE detects PDCCH addressed to P-RNTI, UE may not buffer PDSCH while processing PDCCH addressed to P-RNTI.

Referring to FIG. 5c, in step 560, in case that UE does not receive a new parameter (i.e. crossSlotSchedulingEnabled) or UE does not support cross slot scheduling for paging, UE may monitor PDCCH addressed to P-RNTI.

In step 570, UE may buffer PDSCH while processing PDCCH addressed to P-RNTI. The buffered information may be discarded if upon processing the received PDCCH UE determines that paging message is not scheduled or is scheduled at ‘n+K0’ where K0 is greater than PDCCH processing time.

Embodiment 1-2: In another embodiment of the proposed invention to minimize UE's power consumption operation, transmission and reception of paging may be as follows:

UE which supports cross slot scheduling for paging, may indicate its capability to support cross slot scheduling for paging via UE capability information message to gNB in RRC_CONNECTED. UE may send UE capability information message to gNB in response to UE capability request from gNB. gNB may provide the UE's capabilities to AMF wherein the AMF stores these capabilities.

In case of CN paging, gNB may receive UE's capability to support cross slot scheduling for paging in paging message from AMF

In case of RAN paging, gNB may receive UE's capability to support cross slot scheduling for paging in Core Network assistance information message from AMF

gNB Operation

gNB which supports cross slot scheduling for paging, may broadcast a new parameter i.e. crossSlotSchedulingEnabled in SIB (e.g. SIB1 or SIB 2 or any other SIB). Inclusion of this parameter in SIB is optional. In an embodiment, crossSlotSchedulingEnabled can be included in RRCRelease message wherein the RRCRelease message includes suspend configuration and UE transitions to RRC_INACTIVE state upon receiving the RRCRelease message. In another embodiment, crossSlotSchedulingEnabled can be included in RRCReconfiguration message.

gNB which supports cross slot scheduling for paging, may broadcast a new parameter i.e. paging search space 2 in SIB (e.g. SIB1 or SIB 2 or any other SIB). Inclusion of this parameter in SIB may be optional. In an embodiment, paging search space 2 may be included in RRCRelease message wherein the RRCRelease message includes suspend configuration and UE transitions to RRC_INACTIVE state upon receiving the RRCRelease message. In another embodiment, paging search space 2 may be included in RRCReconfiguration message. Paging search space 2 may indicate a CORESET for receiving PDCCH for paging wherein CORESET indicated by paging search space 2 is different from CORESET indicated by paging search space. In an embodiment, PMOs indicated by paging search space 2 and paging search space may be same.

If gNB has signalled crossSlotSchedulingEnabled flag or paging search space 2:
For scheduling paging message which includes paging for one or more UEs which supports cross slot scheduling (note that gNB knows whether UE supports cross slot scheduling or not as explained earlier):
   gNB may transmit PDCCH addressed to P-RNTI in CORESET indicated by paging search space 2
   PDCCH may include scheduling information for paging message
   PDCCH may or may not include short message
For scheduling paging message which includes paging for one or more UEs which does not support cross slot scheduling
   gNB may transmit PDCCH addressed to P-RNTI in CORESET indicated by paging search space 1
   PDCCH may include scheduling information for paging message
   PDCCH may or may not include short message
For scheduling only short message
   gNB may transmit PDCCH addressed to P-RNTI in CORESET indicated by paging search space 1; PDCCH may include short message

Else:
For scheduling paging message for one or more UEs
   gNB may transmit PDCCH addressed to P-RNTI in CORESET indicated by paging search space 1
   PDCCH may include scheduling information for paging message
   PDCCH may or may not include short message
For scheduling only short message
   gNB may transmit PDCCH addresses to P-RNTI in CORESET indicated by paging search space 1; PDCCH may include short message

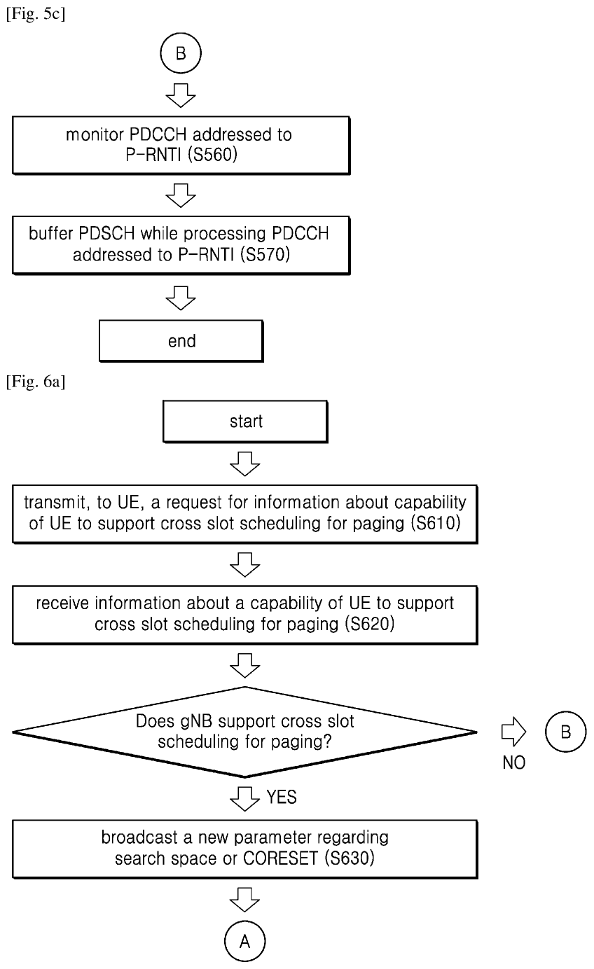

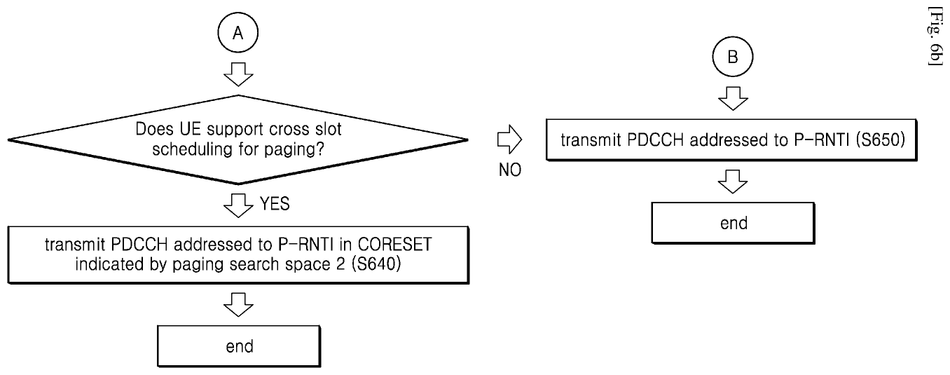

FIGS. 6a and 6b illustrate a flowchart of an operation performed by gNB for paging according to embodiments of the present disclosure.

In step 610, gNB may transmit, to UE, a request for information about capability of UE to support cross slot scheduling for paging. In one embodiment, gNB may receive UE capability information message including information about capability of UE to support cross slot scheduling for paging. Then, gNB may provide information about capability of the UE to support cross slot scheduling for paging to AMF wherein the AMF may store information.

In step 620, gNB may receive information about a capability of UE to support cross slot scheduling for paging. In one embodiment, in case of CN paging, gNB may receive information about capability of UE to support cross slot scheduling for paging in paging message from AMF. In another embodiment, in case of RAN paging, gNB may receive information about capability of UE to support cross slot scheduling for paging in Core Network assistance information message from AMF.

In step 630, in case that gNB supports cross slot scheduling for paging, gNB may broadcast a new parameter regarding search space or CORESET (i.e. paging search space 2 or CORESET 2). Inclusion of this parameter in SIB may be optional. In one embodiment, paging search space 2 or CORESET 2 may be included in SIB (e.g. SIB1 or SIB 2 or any other SIB). In another embodiment, paging search space 2 or CORESET 2 may be included in RRCRelease message wherein the RRCRelease message includes suspend configuration and UE transitions to RRC_INACTIVE state upon receiving the RRCRelease message. In the other embodiment, paging search space 2 or CORESET 2 can be included in RRCReconfiguration message.

Paging search space 2 may indicate a CORESET for receiving PDCCH for paging wherein CORESET indicated by paging search space 2 is different from CORESET indicated by paging search space. In an embodiment, PMOs indicated by paging search space 2 and paging search space may be same.

Referring to FIG. 6b, in step 640, in case that UE supports cross slot scheduling for paging, to schedule paging message, gNB may transmit PDCCH addressed to P-RNTI in CORESET indicated by paging search space 2. In one embodiment, PDCCH may include scheduling information for paging message. In another embodiment, PDCCH may or may not include short message.

In step 650, in case that UE does not support cross slot scheduling for paging, to schedule paging message, gNB may transmit PDCCH addressed to P-RNTI in CORESET indicated by paging search space 1. In one embodiment, PDCCH may include scheduling information for paging message. In another embodiment, PDCCH may or may not include short message.

In case that gNB does not support cross slot scheduling for paging, to schedule paging message, gNB may transmit PDCCH addressed to P-RNTI in CORESET indicated by paging search space 1. In one embodiment, PDCCH may include scheduling information for paging message. In another embodiment, PDCCH may or may not include short message.

Meanwhile, to schedule only short message, gNB may transmit PDCCH addressed to P-RNTI in CORESET indicated by paging search space 1. In one embodiment, PDCCH may include Short message.

In an embodiment, instead of paging search space 2, a CORESET 2 can be signalled. In the above operation, CORESET indicated in paging search space 2 can be replaced by CORESET 2. CORESET indicated in paging search space 1 can be replaced by CORESET 1. CORESET 1 and CORESET 2 are signalled for paging reception.

UE Operation

UE which supports cross slot scheduling for paging, may indicate its capability to support cross slot scheduling for paging via UE capability information message to gNB in RRC_CONNECTED. UE may send UE capability information message to gNB in response to UE capability request from gNB.

UE may acquire the paging configuration from SI in RRC IDLE/RRC INACTIVE

If gNB has signalled crossSlotSchedulingEnabled flag (or paging search space 2) and UE has indicated that it supports cross slot scheduling capability:
UE may monitor PDCCH addressed to P-RNTI in CORESET indicated in paging search space 2 and paging search space 1.
UE may not buffer PDSCH while processing PDCCH addressed to P-RNTI received in CORESET indicated in paging search space 2 or UE may not buffer PDSCH while processing PDCCH addressed to P-RNTI irrespective of whether the PDCCH is monitored in paging search space 2 or paging search space 1.
If PDCCH addressed to P-RNTI received in CORESET indicated in paging search space 2 schedules paging message, UE may receive PDSCH from the slot ‘n+K0’, where ‘n’ is the slot in which UE receives PDCCH addressed to P-RNTI is received.

Else
UE may monitor PDCCH addressed to P-RNTI in CORESET indicated in paging search space 1
UE may buffer PDSCH while processing PDCCH
The buffered information may be discarded if upon processing the received PDCCH UE determines that paging message is not scheduled or is scheduled at ‘n+K0’ where K0 is greater than PDCCH processing time.

In an embodiment, instead of paging search space 2, a CORESET 2 can be signalled. In the above operation, CORESET indicated in paging search space 2 can be replaced by CORESET 2. CORESET indicated in paging search space 1 can be replaced by CORESET 1. CORESET 1 and CORESET 2 are signalled for paging reception.

In an embodiment, if UE receives crossSlotSchedulingEnabled in RRCRelease message as well as in system information, UE may apply crossSlotSchedulingEnabled received in RRCRelease in the above operation. In an embodiment, if UE receives crossSlotSchedulingEnabled in RRCRelease message as well as in system information, UE may apply crossSlotSchedulingEnabled received in RRCRelease in the above operation if the UE is in RRC_INACTIVE.

In an embodiment, if UE receives crossSlotSchedulingEnabled in RRCRelease message as well as in system information, UE may apply crossSlotSchedulingEnabled in RRCRelease in RRC_INACTIVE and UE applies crossSlotSchedulingEnabled in system information in RRC_IDLE. If crossSlotSchedulingEnabled is not received in RRCRelease message, UE may apply crossSlotSchedulingEnabled received in system information in RRC_INACTIVE as well.

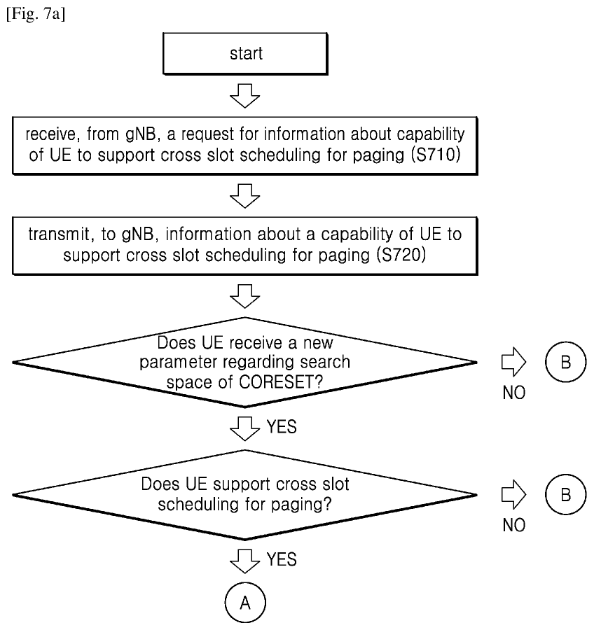

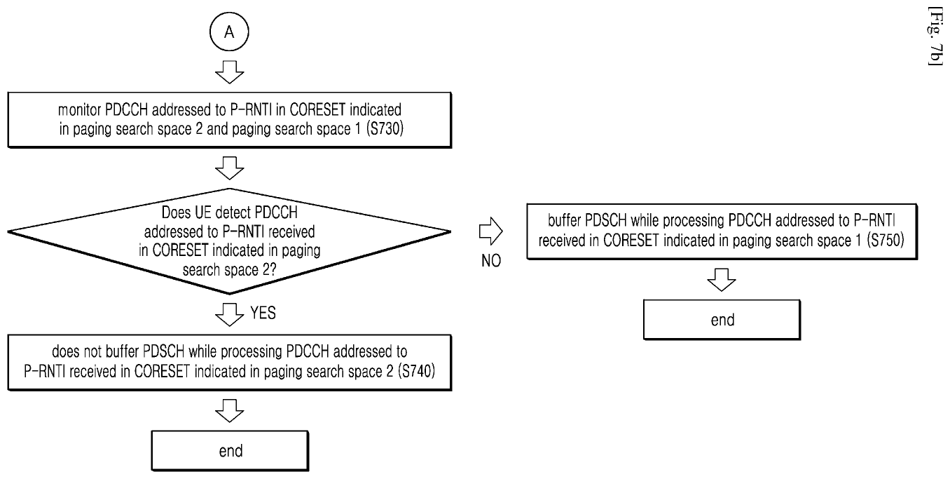

FIGS. 7a, 7b and 7c illustrate a flowchart of an operation performed by UE for paging according to embodiments of the present disclosure.

In step 710, UE may receive from gNB, a request for information about capability of UE to support cross slot scheduling for paging.

In step 720, UE may transmit, to gNB, information about a capability of UE to support cross slot scheduling for paging. In one embodiment, UE may send UE capability information message to gNB in response to the request from gNB. For example, UE which supports cross slot scheduling for paging, may indicate its capability to support cross slot scheduling for paging via UE capability information message to gNB in RRC_CONNECTED.

Referring to FIG. 7b, in step 730, in case that UE receives a new parameter regarding search space or CORESET (i.e. paging search space 2 or CORESET 2) and UE supports cross slot scheduling for paging and UE supports cross slot scheduling for paging, UE may monitor PDCCH addressed to P-RNTI in CORESET indicated in paging search space 2 and paging search space 1.

In step 740, in case that UE detects PDCCH addressed to P-RNTI in CORESET indicated in paging search space 2, UE may not buffer PDSCH while processing PDCCH addressed to P-RNTI received in CORESET indicated in paging search space 2. In one embodiment, if PDCCH addressed to P-RNTI received in CORESET indicated in paging search space 2 schedules paging message, UE may receive PDSCH from the slot ‘n+KO’, where ‘n’ is the slot in which UE receives PDCCH addressed to P-RNTI is received.

In step 750, in case that UE detects PDCCH addressed to P-RNTI received in CORESET indicated in paging search space 1, UE may buffer PDSCH while processing PDCCH addressed to P-RNTI received in CORESET indicated in paging search space 1. In one embodiment, the buffered information may be discarded if upon processing the received PDCCH UE determines that paging message is not scheduled or is scheduled at ‘n+K0’ where K0 is greater than PDCCH processing time. In an embodiment at step 750, in case that UE detects PDCCH addressed to P-RNTI received in CORESET indicated in paging search space 1, UE may not buffer PDSCH while processing PDCCH addressed to P-RNTI received in CORESET indicated in paging search space 1.

Referring to FIG. 7c, in step 760, in case that UE does not receive a new parameter regarding search space or CORESET (i.e. paging search space 2 or CORESET 2) or UE does not cross slot scheduling for paging, UE may monitor PDCCH addressed to P-RNTI in CORESET indicated in paging search space 1. In one embodiment, UE may buffer PDSCH while processing PDCCH addressed to P-RNTI received in CORESET indicated in paging search space 1. The buffered information may be discarded if upon processing the received PDCCH UE determines that paging message is not scheduled or is scheduled at ‘n+K0’ where K0 is greater than PDCCH processing time.

In an embodiment, instead of paging search space 2, a CORESET 2 can be signalled. In the above operation, CORESET indicated in paging search space 2 can be replaced by CORESET 2. CORESET indicated in paging search space 1 can be replaced by CORESET 1. CORESET 1 and CORESET 2 are signalled for paging reception.

Scheduling Information for Paging in Paging Indication

Embodiment 2-1: In one embodiment of the proposed invention to minimize UE's power consumption operation, transmission and reception of paging may be as follows:

Scheduling information (e.g. time and frequency resources, mcs etc) for paging message may be included in DCI of PDCCH transmitted in PMOs of early paging indication. The advantage is that UE need not monitor PMOs of PO if paging is indicated in early paging indication.

UE which supports early paging indication, may indicate its capability to support early paging indication via UE capability information message to gNB in RRC CONNECTED. UE may send UE capability information message to gNB in response to UE capability request from gNB. gNB may provide the UE's capabilities to AMF wherein the AMF stores these capabilities.

In case of CN paging, gNB may receive UE's capability to support early paging indication in paging message from AMF

In case of RAN paging, gNB may receive UE's capability to support early paging indication in Core Network assistance information message from AMF

gNB Operation for Paging One or More UEs Wherein gNB Supports Early Paging Indication

gNB may transmit PDCCH in PMOs of early paging indication corresponding to the PO

gNB may indicate in DCI of early paging indication that there is a paging message
if paging grouping is supported, gNB may indicate the group(s) whose UEs are paged in paging message

If all the UEs which needs to be paged supports early paging indication:
gNB may include scheduling information of paging message in DCI of early paging indication
   In an embodiment, K0 in DCI of early paging indication can be indicated relative to start of PO (i.e. first PMO of PO)
   In another embodiment, K0 in DCI of early paging indication can be indicated relative to slot in which DCI of early paging indication is received
gNB may transmit paging message according to scheduling information in DCI of early paging indication

else:
gNB may not include scheduling information of paging message in DCI of early paging indication
gNB may transmit PDCCH in PMOs of PO
gNB may include scheduling information of paging message in DCI of PDCCH transmitted in PO
gNB may transmit paging message according to scheduling information in DCI of PDCCH transmitted in PO

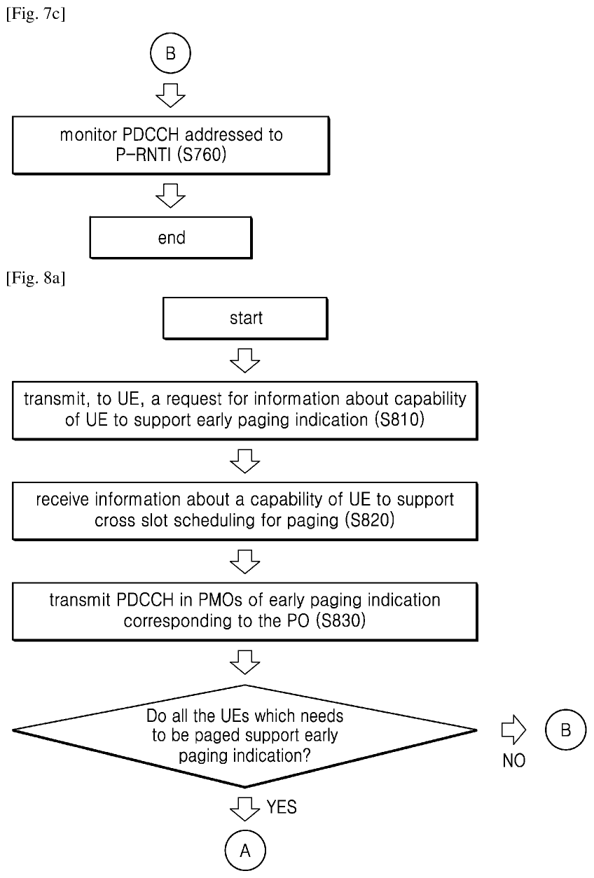

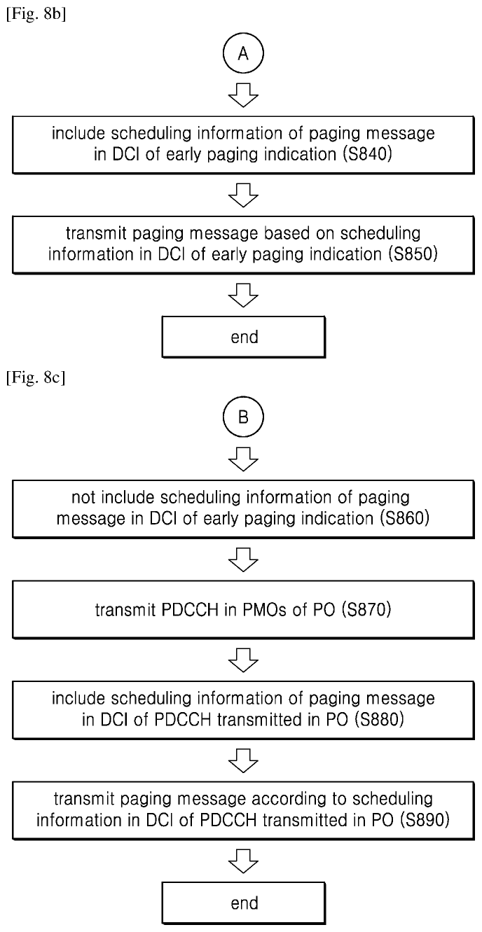

FIGS. 8a, 8b and 8c illustrate a flowchart of an operation performed by gNB for paging according to embodiments of the present disclosure.

In step 810, gNB may transmit, to UE, a request for information about capability of UE to support early paging indication. In one embodiment, gNB may receive UE capability information message including information about capability of UE to support early paging indication. Then, gNB may provide information about capability of the UE to support early paging indication to AMF wherein the AMF may store information.

In step 820, gNB may receive information about a capability of UE to support early paging indication. In one embodiment, in case of CN paging, gNB may receive information about capability of UE to support early paging indication in paging message from AMF. In another embodiment, gNB may receive information about capability of UE to support early paging indication in Core Network assistance information message from AMF.

In step 830, gNB may transmit PDCCH in PDCCH monitoring occasions (PMOs) of early paging indication corresponding to the paging occasion (PO). In one embodiment, gNB may indicate in DCI of early paging indication that there is a paging message. Also, if paging grouping is supported, gNB may indicate the group(s) whose UEs are paged in paging message.

Referring to FIG. 8b, in step 840, in case that all the UEs which needs to be paged support early paging indication, gNB may include scheduling information of paging message in DCI of early paging indication. In one embodiment, KO and scheduling information for PDSCH may be included in DCI of early paging indication. For example, KO in DCI of early paging indication may be indicated relative to start of PO (i.e. first PMO of PO). For another example, KO in DCI of early paging indication may be indicated relative to slot in which DCI of early paging indication is received.

In step 850, gNB may transmit paging message based on scheduling information in DCI of early paging indication. In one embodiment, gNB may transmit PDSCH for paging message in slot ‘n1+KO’ wherein ‘n1’ is the slot corresponding to start of PO (i.e. first PMO of PO). In another embodiment, gNB may transmit PDSCH for paging message in slot ‘n+KO’ wherein ‘n’ is the slot in which UE receives DCI of early paging indication.

Referring to FIG. 8c, in step 860, in case that all the UEs which needs to be paged do not support early paging indication, gNB may not include scheduling information of paging message in DCI of early paging indication. In step 870, gNB may transmit PDCCH in PMOs of PO.

In step 880, gNB may include scheduling information of paging message in DCI of PDCCH transmitted in PO. In one embodiment, KO in DCI of PDCCH transmitted in PO may be indicated relative to start of PO (i.e. first PMO of PO)

In step 890, gNB may transmit paging message according to scheduling information in DCI of PDCCH transmitted in PO. In one embodiment, gNB may transmit PDSCH for paging message in slot ‘n1+KO’ wherein ‘n1’ is the slot corresponding to start of PO (i.e. first PMO of PO).

UE Operation

UE which supports early paging indication, may indicate its capability to support early paging indication via UE capability information message to gNB in RRC CONNECTED. UE may send UE capability information message to gNB in response to UE capability request from gNB.

UE may acquire the paging configuration from SI in RRC IDLE/RRC INACTIVE

If gNB has indicated early paging indication support and UE has indicated that it supports early paging indication capability:
UE may monitor PDCCH in PMOs of early paging indication
UE may receive PDCCH and DCI of received PDCCH indicating that there is paging (for UE's group)
If scheduling information of paging message is included in DCI of early paging indication
   UE may receive paging message according to scheduling information in DCI of early paging indication.
      In an embodiment, KO in DCI of early paging indication may be relative to start of PO (i.e. first PMO of PO)
      In another embodiment, KO in DCI of early paging indication may be relative to slot in which DCI of early paging indication is received
   UE may not monitor PO
Else
   UE may monitor PO
   UE may receive paging message according to scheduling information in DCI of PDCCH transmitted in PO

Key Points:

gNB may include scheduling information for paging message in DCI of early paging indication depending on whether legacy UE is paged or not

UE may receive paging message based on DCI of early paging indication if scheduling information for paging message is included in DCI of early paging indication. Otherwise, UE may receive paging message based on DCI of PDCCH transmitted in PO

Presence/absence indication of scheduling information of paging message in DCI of early paging indication

Monitoring PO or not depending on whether scheduling information for paging message may be included in DCI of early paging indication

Capability signaling (AMF to gNB, UE to network)

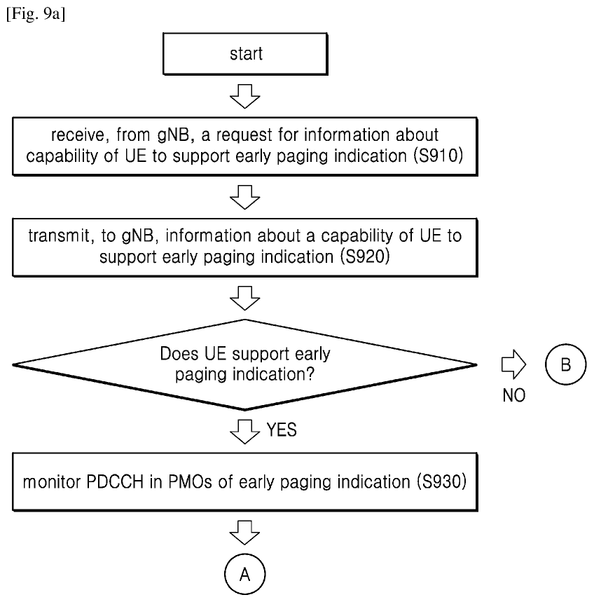

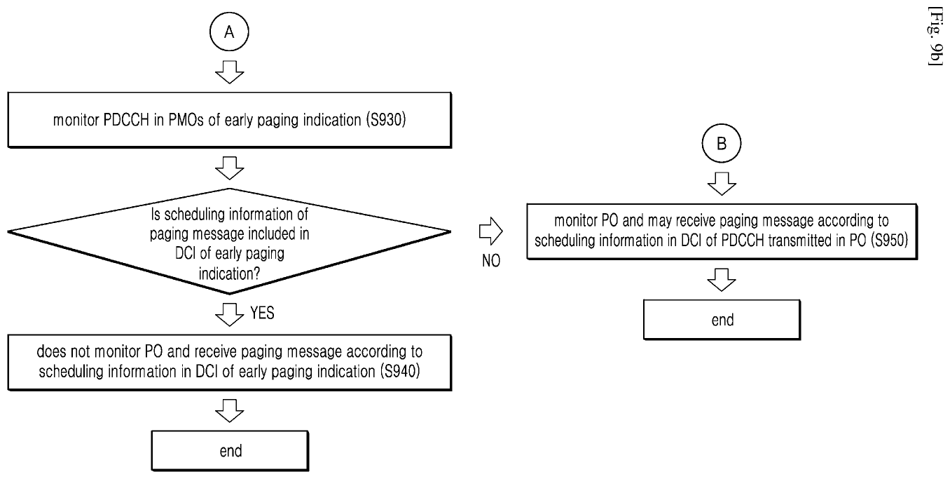

FIGS. 9a and 9b illustrate a flowchart of an operation performed by UE for paging according to embodiments of the present disclosure.

In step 910, UE may receive from gNB, a request for information about capability of UE to support early paging indication.

In step 920, UE may transmit, to gNB, information about a capability of UE to support early paging indication. In one embodiment, UE may send UE capability information message to gNB in response to UE capability request from gNB. For example, UE which supports early paging indication, may indicate its capability to support early paging indication via UE capability information message to gNB in RRC CONNECTED.

Referring to FIG. 9b, in step 930, in case that UE supports early paging indication, UE may monitor PDCCH in PMOs of early paging indication. In one embodiment, UE may receive DCI of received PDCCH indicating that there is paging (for UE's group).

In step 940, in case that scheduling information of paging message is included in DCI of early paging indication, UE may not monitor PO and receive paging message according to scheduling information in DCI of early paging indication. In one embodiment, KO and scheduling information for PDSCH may be included in DCI of early paging indication. For example, KO in DCI of early paging indication may be indicated relative to start of PO (i.e. first PMO of PO). Then, UE may receive PDSCH for paging message in slot ‘n1+KO’ wherein ‘n1’ is the slot corresponding to start of PO (i.e. first PMO of PO). For another example, KO in DCI of early paging indication may be indicated relative to slot in which DCI of early paging indication is received. Then UE may receive PDSCH for paging message in slot ‘n+KO’ wherein ‘n’ is the slot in which UE receives DCI of early paging indication.

In step 950, in case that scheduling information of paging message is not included in DCI of early paging indication, UE may monitor PO and may receive paging message according to scheduling information in DCI of PDCCH transmitted in PO. In one embodiment, KO in DCI of PDCCH transmitted in PO may be indicated relative to start of PO (i.e. first PMO of PO). Then UE may receive PDSCH for paging message in slot ‘n1+KO’ wherein ‘n1’ is the slot corresponding to start of PO (i.e. first PMO of PO).

In case that UE does not support early paging indication, UE may monitor PO and may receive paging message according to scheduling information in DCI of PDCCH transmitted in PO. In one embodiment, KO in DCI of PDCCH transmitted in PO may be indicated relative to start of PO (i.e. first PMO of PO). Then UE may receive PDSCH for paging message in slot ‘n1+KO’ wherein ‘n1’ is the slot corresponding to start of PO (i.e. first PMO of PO).

Embodiment 2-2: In another embodiment of the proposed invention to minimize UE's power consumption operation, transmission and reception of paging may be as follows:

Scheduling information (e.g. time and frequency resources, mcs etc) for paging message may be included in DCI of PDCCH transmitted in PMOs of early paging indication. The advantage is that UE need not monitor PMOs of PO if paging is indicated in early paging indication.

UE which supports early paging indication, may indicate its capability to support early paging indication via UE capability information message to gNB in RRC CONNECTED. UE may send UE capability information message to gNB in response to UE capability request from gNB. gNB may provide the UE's capabilities to AMF wherein the AMF stores these capabilities.

In case of CN paging, gNB may receive UE's capability to support early paging indication in paging message from AMF

In case of RAN paging, gNB may receive UE's capability to support early paging indication in Core Network assistance information message from AMF

gNB Operation for Paging One or More UEs Wherein gNB Supports Early Paging Indication

If one or more UE(s) to be paged support early paging indication:
gNB may transmit PDCCH in PMOs of early paging indication corresponding to the PO
   if paging grouping is supported, gNB may indicate the group(s) whose UEs are paged in paging message
gNB may include scheduling information of paging message in DCI of early paging indication
   In an embodiment, KO in DCI of early paging indication can be indicated relative to start of PO (i.e. first PMO of PO)
   In another embodiment, KO in DCI of early paging indication can be indicated relative to slot in which DCI of early paging indication is received
gNB may transmit paging message according to scheduling information in DCI of early paging indication

If one or more UE(s) to be paged does not support early paging indication
gNB may transmit PDCCH in PMOs of PO
gNB may include scheduling information of paging message in DCI of PDCCH transmitted in PO
gNB may transmit paging message according to scheduling information in DCI of PDCCH transmitted in PO

TB of paging message scheduled by DCI in PO and DCI in early paging indication can be same or different.

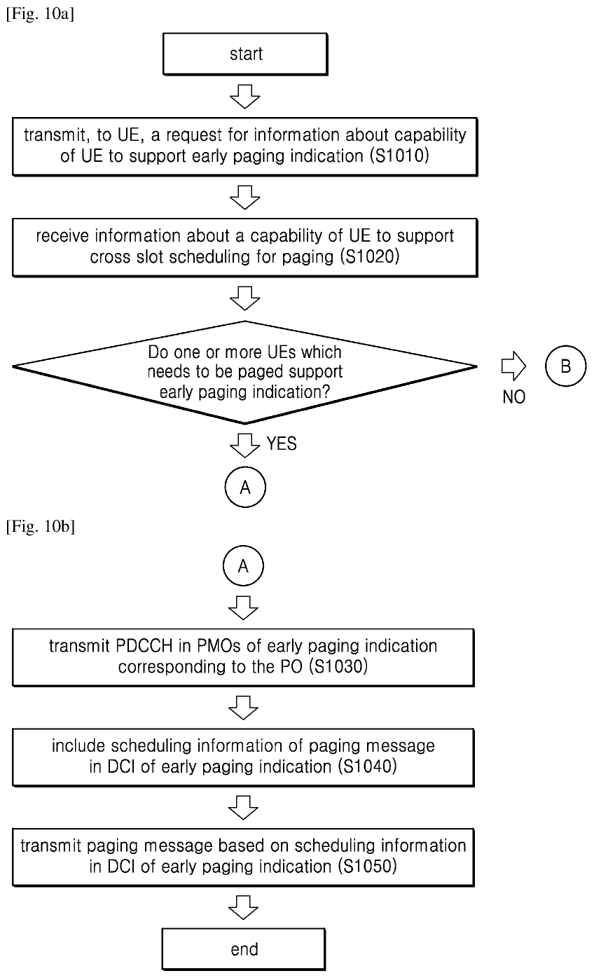

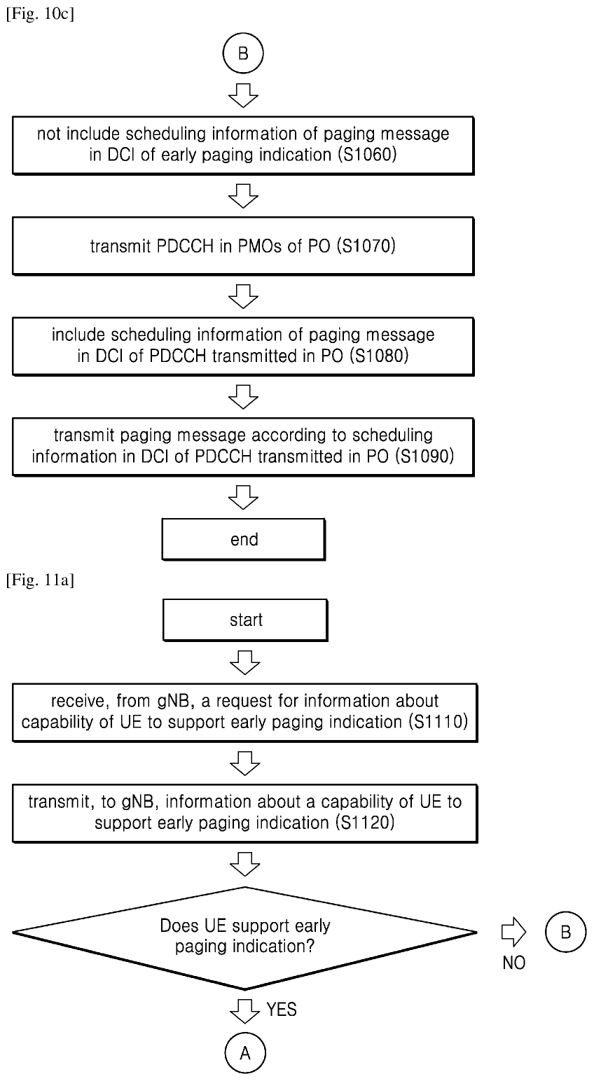

FIGS. 10a, 10b and 10c illustrate a flowchart of an operation performed by gNB for paging according to embodiments of the present disclosure.

In step 1010, gNB may transmit, to UE, a request for information about capability of UE to support early paging indication. In one embodiment, gNB may receive UE capability information message including information about capability of UE to support early paging indication. Then, gNB may provide information about capability of the UE to support early paging indication to AMF wherein the AMF may store information.

In step 1020, gNB may receive information about a capability of UE to support early paging indication. In one embodiment, in case of CN paging, gNB may receive information about capability of UE to support early paging indication in paging message from AMF. In another embodiment, gNB may receive information about capability of UE to support early paging indication in Core Network assistance information message from AMF.

Referring to FIG. 10b, in step 1030, in case that one or more UE(s) which needs to be paged support early paging indication, gNB may transmit PDCCH in PDCCH monitoring occasions (PMOs) of early paging indication corresponding to the paging occasion (PO). In one embodiment, if paging grouping is supported, gNB may indicate the group(s) whose UEs are paged in paging message.

In step 1040, gNB may include scheduling information of paging message in DCI of early paging indication. In one embodiment, KO and scheduling information for PDSCH may be included in DCI of early paging indication. For example, KO in DCI of early paging indication may be indicated relative to start of PO (i.e. first PMO of PO). For another example, KO in DCI of early paging indication may be indicated relative to slot in which DCI of early paging indication is received.

In step 1050, gNB may transmit paging message based on scheduling information in DCI of early paging indication. In one embodiment, gNB may transmit PDSCH for paging message in slot ‘n1+KO’ wherein ‘n1’ is the slot corresponding to start of PO (i.e. first PMO of PO). In another embodiment, gNB may transmit PDSCH for paging message in slot ‘n+KO’ wherein ‘n’ is the slot in which UE receives DCI of early paging indication.

Referring to FIG. 10c, in step 1060, in case that one or more UEs which needs to be paged do not support early paging indication, gNB may not include scheduling information of paging message in DCI of early paging indication. In step 1070, gNB may transmit PDCCH in PMOs of PO.

In step 1080, gNB may include scheduling information of paging message in DCI of PDCCH transmitted in PO. In one embodiment, KO in DCI of PDCCH transmitted in PO may be indicated relative to start of PO (i.e. first PMO of PO)

In step 1090, gNB may transmit paging message according to scheduling information in DCI of PDCCH transmitted in PO. In one embodiment, gNB may transmit PDSCH for paging message in slot ‘n1+KO’ wherein ‘n1’ is the slot corresponding to start of PO (i.e. first PMO of PO).

UE Operation

If UE supports early paging indication:
UE may monitor PDCCH in PMOs of early paging indication
UE may receive PDCCH and DCI of received PDCCH indicates that there is paging (for UE's group)
UE may receive paging message according to scheduling information in DCI of early paging indication.
   In an embodiment, KO in DCI of early paging indication may be relative to start of PO (i.e. first PMO of PO)
   In another embodiment, KO in DCI of early paging indication may be relative to slot in which DCI of early paging indication is received
UE may not monitor PO

Else
UE may monitor PO
UE may receive paging message according to scheduling information in DCI of PDCCH transmitted in PO

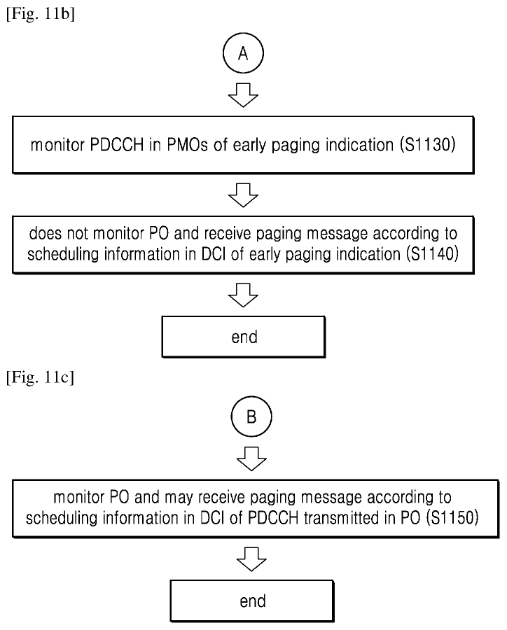

FIGS. 11a, 11b and 11c illustrate a flowchart of an operation performed by UE for paging according to embodiments of the present disclosure.

In step 1110, UE may receive from gNB, a request for information about capability of UE to support early paging indication.

In step 1120, UE may transmit, to gNB, information about a capability of UE to support early paging indication. In one embodiment, UE may send UE capability information message to gNB in response to UE capability request from gNB. For example, UE which supports early paging indication, may indicate its capability to support early paging indication via UE capability information message to gNB in RRC CONNECTED.

Referring to FIG. 11b, in step 1130, in case that UE supports early paging indication, UE may monitor PDCCH in PMOs of early paging indication. In one embodiment, UE may receive DCI of received PDCCH indicating that there is paging (for UE's group). Also, UE may receive scheduling information of paging message included in DCI of early paging indication.

In step 1140, UE may not monitor PO and receive paging message according to scheduling information in DCI of early paging indication. In one embodiment, KO and scheduling information for PDSCH may be included in DCI of early paging indication. For example, KO in DCI of early paging indication may be indicated relative to start of PO (i.e. first PMO of PO). Then, UE may receive PDSCH for paging message in slot ‘n1+KO’ wherein ‘n1’ is the slot corresponding to start of PO (i.e. first PMO of PO). For another example, KO in DCI of early paging indication may be indicated relative to slot in which DCI of early paging indication is received. Then UE may receive PDSCH for paging message in slot ‘n+KO’ wherein ‘n’ is the slot in which UE receives DCI of early paging indication.

Referring to FIG. 11c, in step 1150, in case that UE does not support early paging indication, UE may monitor PO and may receive paging message according to scheduling information in DCI of PDCCH transmitted in PO. In one embodiment, KO in DCI of PDCCH transmitted in PO may be indicated relative to start of PO (i.e. first PMO of PO). Then UE may receive PDSCH for paging message in slot ‘n1+KO’ wherein ‘n1’ is the slot corresponding to start of PO (i.e. first PMO of PO).

L1/L2 Centric Inter Cell Mobility

In the current design of inter cell mobility, UE receives the RRM measurement configuration from serving cell. UE performs L3 measurements based on the configuration and when criteria to send measurement report is met, UE sends the measurement report to the serving cell. Cell Level Mobility requires explicit RRC signalling to be triggered, i.e. handover. The handover mechanism triggered by RRC requires the UE at least to reset the MAC entity and re-establish RLC. RRC managed handovers with and without PDCP entity re-establishment are both supported. For DRBs using RLC Acknowledged Mode (AM), PDCP can either be re-established together with a security key change or initiate a data recovery procedure without a key change. For DRBs using RLC Unacknowledged Mode (UM) and for SRBs, PDCP can either be re-established together with a security key change or remain as it is without a key change. Data forwarding, in-sequence delivery and duplication avoidance at handover can be guaranteed when the target cell uses the same DRB configuration as the source cell.

Beam Level Mobility within a serving cell is also supported. Beam Level Mobility does not require explicit RRC signalling to be triggered. The gNB provides via RRC signalling the UE with measurement configuration containing configurations of SSB/CSI resources and resource sets, reports and triggers states for triggering channel and interference measurements and reports. Beam Level Mobility is then dealt with at lower layers by means of physical layer and MAC layer control signalling, and RRC is not required to know which beam is being used at a given point in time. SSB-based Beam Level Mobility is based on the SSB associated to the initial DL BWP and can only be configured for the initial DL BWPs and for DL BWPs containing the SSB associated to the initial DL BWP. For other DL BWPs, Beam Level Mobility can only be performed based on CSI-RS.

In R15/16 of 3GPP standards, NR serving cell can have two Transmission Reception Points (TRPs) but these TRPs should have same Physical Cell ID (PCI) so that beam management is only possible in the same PCI. Beam change from one TRP (PCI 1) to the other TRP (PCI 2) can be handled by “HO+beam management or mobility” procedure but it requires long latency. So it is studied to enable changing of beam from one PCI to the other PCI. One or more of the following options can be performed for L1/L2 centric inter cell mobility.

### Embodiment 3-1

Step 1: TCI states and beam related configurations for non-serving cell (can also be referred as additional serving cell or additional TRP on different PCI of serving cell) may be configured via the serving cell. (say Cell A) If serving cell's PCI is X, TRP of PCI X of serving cell can be referred as primary TRP and TRP of PCI Y for the serving cell can be referred as additional TRP.

Step 2: UE may perform beam measurement for non-serving cells. UE may report the beam measurement of non-serving cells to the serving cell

Step 3: Serving cell may coordinate with non-serving cells to determine whether to activate TCI state for a non-serving cell (say Cell B). In an embodiment, this decision may be taken by the serving cell. In another embodiment, this decision may be taken by non-serving cell.

Step 4: TCI state indication for the non-serving cell (Cell B) may be received while UE is in source cell (i.e. current serving cell, Cell A)

Step 5: Handover procedure as in legacy may be triggered and executed towards a target cell (i.e. Cell B)

Step 6: Upon handover completion, UE may apply the activated TCI state received in step 4 for receiving PDCCH from cell B.

### Embodiment 3-2

Step 1: TCI states and beam related configurations for non-serving cell (can also be referred as additional serving cell or additional TRP on different PCI of serving cell) may be configured via the serving cell (Cell A). If serving cell's PCI is X, TRP of PCI X of serving cell can be referred as primary TRP and TRP of PCI Y for the serving cell can be referred as additional TRP.

Step 2: UE may perform beam measurement for non-serving cells. UE may report the beam measurement of non-serving cells to the serving cell.

Step 3: Serving cell may coordinate with non-serving cells to determine whether to activate TCI state for a non-serving cell (say Cell B). In an embodiment, this decision may be taken by the serving cell. In another embodiment, this decision may be taken by non-serving cell.

Step 4: TCI state indication for the non-serving cell (Cell B) may be received while UE is in source cell (i.e. current serving cell A).

UE may send ACK for this indication via cell A.
In an embodiment, whether to perform RA or not may be indicated along with TCI state indication
In an embodiment, whether to re-establish RLC or may can be indicated along with TCI state indication
In an embodiment, whether to reset MAC or not may be indicated along with TCI state indication

Step 5: UE may start receiving/transmitting physical layer channels from non-serving cell (Cell B)
Upper layer configurations may be unchanged
UE may continue to use current security key, C-RNTI.
PCI of Cell2 may be used
For serving cell measurements upon this step, measurements may be based on Cell B. Alternately, measurements may be based on cell A.

Step 6: Reconfiguration with reconfigurtaionwithSync or without reconfigurtaion-withSync may be performed, as triggered by RRC signalling
Note: if TA is not same for cell A and cell A, RA needs to be performed upon step 4. Whether to perform RA or not can be indicated along with TCI state indication in step 4. RA configuration of cell B can be configured in step1, if not configured UE can apply configuration of cell A.

In an embodiment, MAC operation upon receiving TCI state indication for the non-serving cell (can also be referred as additional serving cell or additional TRP on different PCI of serving cell) may be listed in table 3 below

TABLE 3

| | Action upon beam-switching by using L1/L2 |
|---|---|
| | control signaling from the (old) serving cell to |
| | the non serving cell (or candidate target cell) |
| | or beam switching from primary TRP (PCI |
| | 1_to additional TRP (PCI 2) |
| initialization of Bj for each logical channel | Not needed |
| timeAlignmentTimers | No need to stop. Assumption is that timing is |
| (Timing allignment timers, one Timing | same between (old) serving cell to the candidate |
| allignment timer is maintained per Timing | target cell |
| Advance Group. There can be upto two TAGs | |
| per MAC entity i.e. per cell group, Primary | |
| TAG and Secondary TAG. A TAG is a group | |
| of Serving Cells that is configured by RRC | |
| and that, for the cells with a UL configured, | |
| using the same timing reference cell and the | |
| same Timing Advance value. A Timing | |
| Advance Group containing the SpCell of a | |
| MAC entity is referred to as Primary Timing | |
| Advance Group (PTAG), whereas the term | |
| Secondary Timing Advance Group (STAG) | |
| refers to other TAGs. | |
| ongoing RACH procedure | should be stopped and MsgA/Msg3 buffer |
| | should be flushed. |
| triggered Scheduling Request procedure | No need to cancel |
| triggered Buffer Status Reporting procedure | No need to cancel |
| triggered consistent LBT failure | Should be cancelled |
| triggered BFR | Should be cancelled |
| (i.e. Beam failure recovery) | |
| triggered Sidelink Buffer Status Reporting | No need to cancel |
| procedure | |
| UL HARQ | Option 1: NDIs for all uplink HARQ processes |
| | should be set to the value 0. |
| | Option 2: We can consider HARQ |
| | retransmissions of an ongoing HARQ process on |
| | the new cell. Do not set NDIs for all uplink HARQ |
| | processes to the value 0 |
| | Whether to continue ongoing HARQ process or |
| | not (i.e. option 1 or option 2) can be indicated via |
| | RRC signaling or in L1/L2 control signaling |
| | activating the TCI state |
| DL HARQ | Option 1: for each DL HARQ process, the next |
| | received transmission for a TB should be |
| | considered as the very first transmission. Soft |
| | buffers for all DL HARQ processes should be |
| | flushed. |
| | Note that currently intial HARQ transmission |
| | and HARQ retransmissions for a HARQ process |
| | are from same cell. |
| | Option 2: We can consider HARQ |
| | retransmissions of an ongoing HARQ process on |
| | the new cell. |
| | Whether to continue ongoing HARQ process or |
| | not (i.e. option 1 or option 2) can be indicated via |
| | RRC signaling or in L1/L2 control signaling |
| | activating the TCI state. |
| BFI_COUNTERS (BFI_COUNTER is a | Should be reset |
| counter for beam failure instance indication | |
| as specified in TS 38.321) | |
| LBT_COUNTERS (LBT_COUNTER is a | Should be reset |
| counter for LBT failure indication as | |
| specified in TS 38.321) | |
| PHR (Power Headroom) report trigger | Option 1: PHR report is triggered. |
| The Power Headroom reporting procedure | Option 2: PHR report is not triggered. |
| as specified in TS 38.321 is used to provide | Whether to perform option 1 or option 2 can be |
| the serving gNB with the following | indicated via RRC signaling or in L1/L2 control |
| information: | signaling activating the TCI state. |
| Type 1 power headroom: the difference | |
| between the nominal UE maximum transmit | |
| power and the estimated power for UL-SCH | |
| transmission per activated Serving Cell; | |
| Type 2 power headroom: the | |
| difference between the nominal UE | |
| maximum transmit power and the estimated | |
| power for UL-SCH and PUCCH | |
| transmission on SpCell of the other MAC | |
| entity (i.e. E-UTRA MAC entity in EN-DC, | |
| NE-DC, and NGEN-DC cases); | |
| Type 3 power headroom: the | |
| difference between the nominal UE | |
| maximum transmit power and the estimated | |
| power for SRS transmission per activated | |
| Serving Cell; | |
| PHR periodic timer | Option 1: Timer is restarted, when the first UL |
| | resource is allocated for a new transmission upon |
| | L1/L2 control signaling activating the TCI state. |
| | Option 2: Timer is not re-started |
| | Whether to perform option 1 or option 2 can be |
| | indicated via RRC signaling or in L1/L2 control |
| | signaling activating the TCI state. |

### Embodiment 3-3

Step 1: Complete configuration of non-serving cells (can also be referred as additional serving cell or additional TRP on different PCI of serving cell) may be received in advance via RRC signaling. TCI states and beam related configurations for non-serving cell may be configured via the serving cell (Cell A)

Step 2: UE may perform beam measurement for non-serving cells. UE may report the beam measurement of non-serving cells to the serving cell

Step 3: Serving cell may coordinate with non-serving cells to determine whether to activate TCI state for a non-serving cell (say Cell B). In an embodiment, this decision may be taken by the serving cell. In another embodiment, this decision may be taken by non-serving cell.

Step 4: TCI state indication for the non-serving cell (Cell B) may be received while UE is in source cell (i.e. current serving cell A).

Step 5: UE may execute handover from Cell A to Cell B using RRC configuration of Cell B received in step 1

Step 6: Upon handover completion, UE may apply the activated TCI state received in step 4.

(Un-)Availability of TRS/CSI RSs for RRC IDLE and RRC_INACTIVE UEs

In RRC IDLE and RRC INACTIVE state, UE uses SSBs for Automatic Gain Control (AGC), time/frequency tracking, Radio Resource Management (RRM) measurement for serving cell, RRM measurement for neighbor cell and for paging reception. SSBs comprising of PSS/SSS/PBCH is periodically broadcasted by a cell. Since the periodicity of SSBs can be longer it is being discussed that TRS/CSI-RS occasion(s) that are configured for connected mode UEs in a cell can be shared to idle/inactive mode UEs. Idle/inactive UE may use the TRS/CSI-RS occasion(s) that are shared to it for functionalities such as AGC, time/frequency tracking, RRM measurement for serving cell, RRM measurement for neighbor cell and for paging reception. The configuration (such time and frequency resources, periodicity, etc.) of TRS/CSI-RS occasion(s) for idle/inactive mode UE(s) is provided by RRC signaling in system information.

TRS/CSI RS can be dynamically switched on/OFF in a cell. In case TRS/CSI RS is switched off, gNB can remove the configuration of TRS/CSI RS occasions from SIB and send SI update notification to UE. In case TRS is switched on, gNB can add the configuration of TRS/CSI RS occasions in SIB and send SI update notification to UE. The above approach is simple and reuses existing SI framework. However, this would require UE to acquire SIB1 every time TRS is switched on/off. It may also impact other UEs who are not interested in TRS/CSI RS as they all will acquire SIB1 upon receiving SI update notification and determine which SIB is updated. So an enhanced method of indicating availability/unavailability of TRS/CSI RSs for RRC IDLE and RRC INACTIVE UEs is needed.

SIB X or SIB 1 may include 1 bit for each TRS/CSI RS resource set. Bit may be set to 1, if corresponding TRS/CSI RS is ON (i.e. being transmitted). Bit may be set to 0, if corresponding TRS/CSI RS is OFF

1 bit TrsNotification may also be included in short message. Which resource sets are on/offed may be indicated in SIB X or SIB1

In one embodiment, upon receiving TrsNotification (in paging DCI or in DCI of early paging indication), UE may acquire SIB 1. SIB1 may indicate which resource sets are on/offed. In an embodiment, paging DCI or in DCI of early paging indication may indicate which resource sets are on/offed.

In another embodiment, upon receiving TRSnotification (in paging DCI or in DCI of early paging indication), UE may acquire SIB1 to get scheduling info of SIB X. UE may acquire SIB X. SIBX may indicate which resource sets are on/offed.

Table 4 is an example of Short Message including trsNotification. Bit 1 is the most significant bit.

TABLE 4

| Bit | Short Message |
|---|---|
| 1 | SysteminfoModification |
| | If set to 1: indication of a BCCH modification |
| | other than SIB6, SIB7 and SIB8. |
| 2 | etwsAndCmasIndication |
| | If set to 1: indication of an ETWS primary notification |
| | and/or an ETWS secondary notification and/or a CMAS |
| | notification. |
| 3 | trsNotification |
| | if set to 1: indication of an TRS availability |
| | notification |
| 4 | CsirsNotification |
| | if set to 1: indication of an CSI RS availability |
| | notification |
| 5-8 | Reserved |

Avoiding Unnecessary Paging Receptions

Typically, when a network has a paging message for a UE, it pages the UE in the last cell where UE was at the time of entering RRC_IDLE/RRC_INACTIVE state. If paging response is not received, network pages the UEs over more cells. If paging response is not received, network pages the UEs over further more cells. These retransmission of paging increases false alarms for other UEs.

To reduce the false alarms following operation can be performed:

1. Network may send to UE a list of cells for each paging transmission. For example, let's say paging is transmitted upto N times. Network may send UE, N list of cells, where each list includes one or more cell Ids. Network may also indicate association between list and transmission number. In an embodiment, ith list may correspond to ith transmission number. In another embodiment, transmission number corresponding to a list may be explicitly indicated in the list. In an embodiment, the list corresponding to 1st transmission may include only one cell and the cell may be the last cell where UE was at the time of entering RRC_IDLE/RRC_INACTIVE state. The signalling of list corresponding to 1st transmission may be skipped. In an embodiment, N may be one and signalling of list corresponding to this can be skipped, wherein the list includes only one cell and the cell is the last cell where UE was at the time of entering RRC_IDLE/RRC_INACTIVE state.

2. When network sends paging message, the paging message may indicate the transmission number associated with the paging message. In an embodiment, transmission number may be included in the paging DCI or DCI of early paging indication. The transmission number may be included separately for each paging group/sub groups.

3. When the UE receives paging DCI or DCI of early paging indication including the transmission number (and if paging is for UE's subgroup when subgroup info is included in DCI):
UE may check if the camped cell or current serving from which UE has received the paging DCI or DCI of early paging indication, is included in list of cells corresponding to the transmission number
   If yes, UE may receive the scheduled paging message.
   If no, UE may not receive the scheduled paging message.

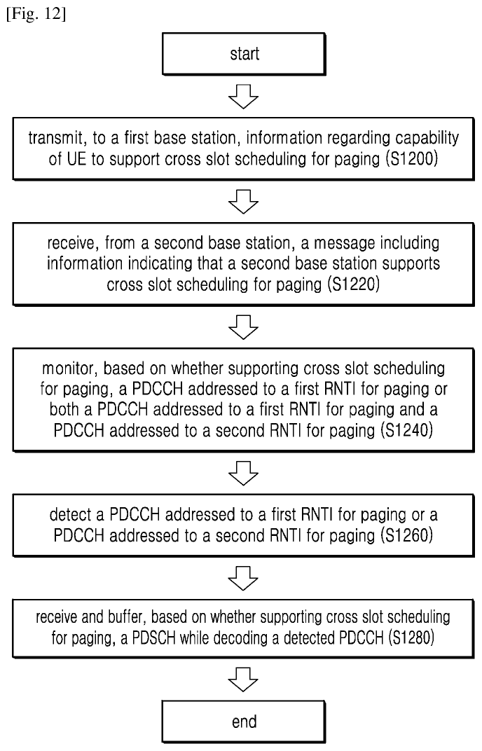

FIG. 12 illustrates a flowchart of an operation performed by UE for paging according to embodiments of the present disclosure.

In step 1200, UE may transmit, to a first base station, information regarding capability of UE to support cross slot scheduling for paging. In one embodiment, UE may receive, from a first base station, a request for information regarding capability of UE to support cross slot scheduling for paging. Also, UE may transmit, to a base station, information regarding capability of UE to support cross slot scheduling for paging in response to the request.

In step 1220, UE may receive, from a second base station, a message including information indicating that a second base station supports cross slot scheduling for paging. In one embodiment, information indicating that base station supports cross slot scheduling for paging may be expressed as a parameter (i.e. crossSlotSchedulingEnabled).

In one embodiment, in case that UE does not receive a message including information indicating that a second base station supports cross slot scheduling for paging, UE may monitor a PDCCH addressed to a first RNTI for paging. Also, UE may detect a PDCCH addressed to a first RNTI for paging. Then UE may receive and buffer a PDSCH while decoding a PDCCH addressed to a first RNTI for paging.

In step 1240, UE may monitor, based on whether supporting cross slot scheduling for paging, a PDCCH addressed to a first RNTI for paging or both a PDCCH addressed to a first RNTI for paging and a PDCCH addressed to a second RNTI for paging. In one embodiment, a first radio network temporary identifier (RNTI) for paging may refer to a P-RNTI. Also, a second RNTI for paging may refer to a P-RNTI 1. Meanwhile, P-RNTI 1 or P-RNTI is only an example and a name referring to a RNTI for paging is not limited thereto.

In step 1260, UE may detect a PDCCH addressed to a first RNTI for paging or a PDCCH addressed to a second RNTI for paging.

In step 1280, UE receive and buffering, based on whether supporting cross slot scheduling for paging, a PDSCH while decoding a detected PDCCH.

In one embodiment, in case that UE supports cross slot scheduling for paging, UE may monitor both a PDCCH addressed to a first RNTI for paging and a PDCCH addressed to a second RNTI. Also, UE may not receive and buffer a PDSCH while decoding a PDCCH addressed to a first RNTI for paging or a PDCCH addressed to a second RNTI.

In one embodiment, a PDCCH addressed to a second RNTI for paging may include scheduling information for a paging message. Then UE may receive a PDSCH including a paging message based on a scheduling information for a paging message.

In another embodiment, in case that UE does not support cross slot scheduling for paging, UE may monitor a PDCCH addressed to a first RNTI for paging. Also, UE may receive and buffer a PDSCH while decoding a PDCCH addressed to a first RNTI for paging.

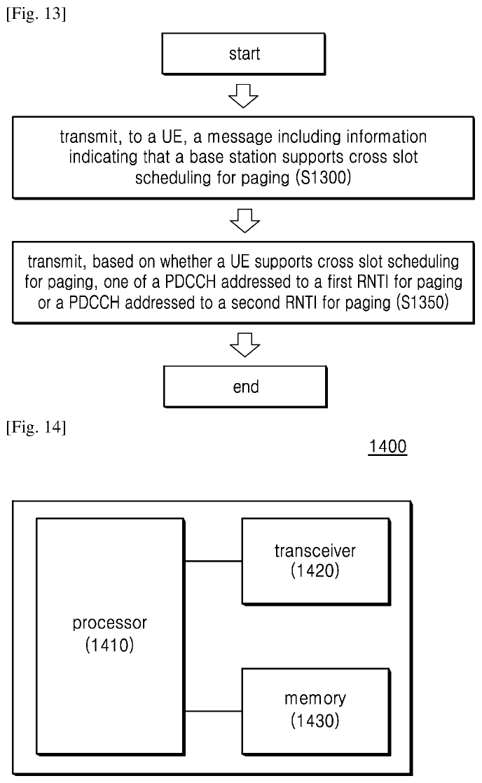

FIG. 13 illustrates a flowchart of an operation performed by a base station for paging according to embodiments of the present disclosure.

In step 1300, a base station may transmit, to a user equipment (UE), a message including information indicating that base station supports cross slot scheduling for paging. In one embodiment, information indicating that base station supports cross slot scheduling for paging may be expressed as a parameter (i.e. crossSlotSchedulingEnabled).

In one embodiment, a base station may transmit, to a UE, a request for information about capability of the UE to support cross slot scheduling for paging. Then a base station may receive, from a UE, information regarding capability of a UE to support cross slot scheduling for paging and transmit, to a network entity, information regarding capability of a UE to support cross slot scheduling for paging.

In one embodiment, in case of core network (CN) paging, a base station may receive information regarding capability of a UE to support cross slot scheduling for paging in a paging message transmitted from a network entity. In another embodiment, in case of radio access network (RAN) paging, a base station may receive information regarding capability of a UE to support cross slot scheduling for paging in a core network assistance information message transmitted from a network entity.

In step 1350, base station may transmit, based on whether UE supports cross slot scheduling for paging, one of a PDCCH addressed to a first RNTI for paging or a PDCCH addressed to a second RNTI for paging.

In one embodiment, in case that the UE supports cross slot scheduling for paging, a base station may transmit a PDCCH addressed to a second RNTI for paging. For example, a PDCCH addressed to a second RNTI for paging may include one of following: scheduling information for a paging message; or scheduling information for a paging message and a short message. Meanwhile, a second RNTI for paging may refer to a P-RNTI 1, but P-RNTI 1 is only an example and a name referring to the RNTI for paging is not limited thereto.

In another embodiment, in case that the UE does not support cross slot scheduling for paging, a base station may transmit a PDCCH addressed to a first RNTI for paging. For example, a PDCCH addressed to a first RNTI for paging may include one of following: scheduling information for a paging message; a short message; or scheduling information for a paging message and a short message. Meanwhile, a first RNTI for paging may refer to a P-RNTI.

FIG. 14 is a diagram illustrating a UE 1400 according to an embodiment of the present disclosure.

Referring to the FIG. 14, the UE 1400 may include a processor 1410, a transceiver 1420 and a memory 1430. However, all of the illustrated components are not essential. The UE 1400 may be implemented by more or less components than those illustrated in the FIG. 14. In addition, the processor 1410 and the transceiver 1420 and the memory 1430 may be implemented as a single chip according to another embodiment.

The aforementioned components will now be described in detail.

The processor 1410 may include one or more processors or other processing devices that control the proposed function, process, and/or method. Operation of the UE 1400 may be implemented by the processor 1410.

The transceiver 1420 may be connected to the processor 1410 and transmit and/or receive a signal. In addition, the transceiver 1420 may receive the signal through a wireless channel and output the signal to the processor 1410. The transceiver 1420 may transmit the signal output from the processor 1410 through the wireless channel.

The memory 1430 may store the control information or the data included in a signal obtained by the UE 1400. The memory 1430 may be connected to the processor 1410 and store at least one instruction or a protocol or a parameter for the proposed function, process, and/or method. The memory 1430 may include read-only memory (ROM) and/or random access memory (RAM) and/or hard disk and/or CD-ROM and/or DVD and/or other storage devices.

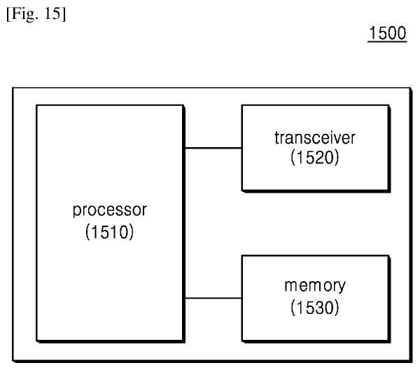

FIG. 15 is a diagram illustrating a base station 1500 according to an embodiment of the present disclosure.

Referring to the FIG. 15, the base station 1500 may include a processor 1510, a transceiver 1520 and a memory 1530. However, all of the illustrated components are not essential. The BS 1500 may be implemented by more or less components than those illustrated in the FIG. 15. In addition, the processor 1510 and the transceiver 1520 and the memory 1530 may be implemented as a single chip according to another embodiment.

The aforementioned components will now be described in detail.

The processor 1510 may include one or more processors or other processing devices that control the proposed function, process, and/or method. Operation of the base station 1500 may be implemented by the processor 1510.

The transceiver 1520 may be connected to the processor 1510 and transmit and/or receive a signal. In addition, the transceiver 1520 may receive the signal through a wireless channel and output the signal to the processor 1510. The transceiver 1520 may transmit the signal output from the processor 1510 through the wireless channel.

The memory 1530 may store the control information or the data included in a signal obtained by the base station 1500. The memory 1530 may be connected to the processor 1510 and store at least one instruction or a protocol or a parameter for the proposed function, process, and/or method. The memory 1530 may include read-only memory (ROM) and/or random access memory (RAM) and/or hard disk and/or CD-ROM and/or DVD and/or other storage devices.

Methods according to the claims of the disclosure or the various embodiments of the disclosure described in the specification may be implemented in hardware, software, or a combination of hardware and software.

When implemented in software, a computer-readable storage medium storing one or more programs (software modules) may be provided. One or more programs stored in the computer-readable storage medium are configured for execution by one or more processors in an electronic device. The one or more programs may include instructions that cause the electronic device to perform the methods in accordance with the claims of the disclosure or the various embodiments of the disclosure described in the specification.

The programs (software modules, software) may be stored in a random access memory (RAM), a non-volatile memory including a flash memory, a read only memory (ROM), an electrically erasable programmable ROM (EEPROM), a magnetic disc storage device, a compact disc-ROM (CD-ROM), a digital versatile disc (DVD) or other types of optical storage device, and/or a magnetic cassette. Alternatively, the programs may be stored in a memory including a combination of some or all of them. There may be a plurality of memories.

The program may also be stored in an attachable storage device that may be accessed over a communication network including the Internet, an intranet, a Local Area Network (LAN), a wide area network (WAN), or a storage area network (SAN), or a combination thereof. The storage device may be connected to an apparatus performing the various embodiments of the disclosure through an external port. In addition, a separate storage device in the communication network may be connected to the apparatus performing the various embodiments of the disclosure.

In the various embodiments of the disclosure, a component is represented in a singular or plural form. It should be understood, however, that the singular or plural representations are selected appropriately according to the situations presented for convenience of explanation, and the disclosure is not limited to the singular or plural form of the component. Further, the component expressed in the plural form may also imply the singular form, and vice versa.

While the disclosure has been shown and described with reference to various embodiments thereof, it will be understood by those skilled in the art that various changes in form and details may be made therein without departing from the spirit and scope of the disclosure as defined by the appended claims and their equivalents.

1-15. (canceled)

16. A method performed by a terminal in a wireless communication system, the method comprising:
receiving, from a first cell, beam related configuration information for a second cell, wherein the first cell and the second cell correspond to different physical cell identifier (PCI);
performing a beam measurement for the second cell and reporting a result of the beam measurement to the first cell, wherein at least one transmission configuration indicator (TCI) state associated with the second cell is activated based on the reporting;
receiving, from the first cell, information indicating the activated at least one TCI state associated with the second cell; and
receiving downlink data from the second cell or transmitting uplink data to the second cell, based on the information indicating the activated at least one TCI state.

17. The method of claim 16, wherein a serving cell is changed from the first cell to the second cell, based on the reporting.

18. The method of claim 17, further comprising:
receiving radio resource control (RRC) configuration information related to the second cell for a serving cell change, wherein the serving cell is changed based on the RRC configuration information.

19. The method of claim 16,
wherein the first cell corresponds to a first transmission and reception point (TRP) with a first PCI,
wherein the second cell corresponds to a second TRP with a second PCI, and
wherein the first TRP and the second TRP are associated with a serving cell.

20. The method of claim 19, further comprising:
transmitting, to the first cell, acknowledgement (ACK) information for the information indicating the activated at least one TCI state.

21. The method of claim 19, further comprising:
performing a beam switching from the first TRP to the second TRP, based on the information indicating the activated at least one TCI state associated with the second cell; and
performing at least one medium access control (MAC) operation, based on the beam switching.

22. The method of claim 19,
wherein the information indicating the activated at least one TCI state further indicates whether to perform a random access (RA) procedure or not, and
wherein the RA procedure is performed in case that the first cell and the second cell correspond to different timing advance (TA).

23. The method of claim 19, wherein the information indicating the activated at least one TCI state further indicates whether to re-establish a radio link control (RLC) or not.

24. The method of claim 19, wherein the information indicating the activated at least one TCI state further indicates whether to reset a medium access control (MAC) or not.

25. The method of claim 19, wherein the first cell and the second cell are associated with the same security key.

26. A terminal in a wireless communication system, the terminal comprising:
a transceiver; and
at least one processor coupled with the transceiver and configured to:
receive, from a first cell, beam related configuration information for a second cell, wherein the first cell and the second cell correspond to different physical cell identifier (PCI),
perform a beam measurement for the second cell and report a result of the beam measurement to the first cell, wherein at least one transmission configuration indicator (TCI) state associated with the second cell is activated based on the reporting,
receive, from the first cell, information indicating the activated at least one TCI state associated with the second cell, and
receive downlink data from the second cell or transmit uplink data to the second cell, based on the information indicating the activated at least one TCI state.

27. The terminal of claim 26, wherein a serving cell is changed from the first cell to the second cell, based on the reporting.

28. The terminal of claim 27, wherein the at least one processor is further configured to:
receive radio resource control (RRC) configuration information related to the second cell for a serving cell change,
wherein the serving cell is changed based on the RRC configuration information.

29. The terminal of claim 26,
wherein the first cell corresponds to a first transmission and reception point (TRP) with a first PCI,
wherein the second cell corresponds to a second TRP with a second PCI, and
wherein the first TRP and the second TRP are associated with a serving cell.

30. The terminal of claim 29, wherein the at least one processor is further configured to:
transmit, to the first cell, acknowledgement (ACK) information for the information indicating the activated at least one TCI state.

31. The terminal of claim 29, wherein the at least one processor is further configured to:
perform a beam switching from the first TRP to the second TRP, based on the information indicating the activated at least one TCI state associated with the second cell; and
perform at least one medium access control (MAC) operation, based on the beam switching.

32. The terminal of claim 29,
wherein the information indicating the activated at least one TCI state further indicates whether to perform a random access (RA) procedure or not, and
wherein the RA procedure is performed in case that the first cell and the second cell correspond to different timing advance (TA).

33. The terminal of claim 29, wherein the information indicating the activated at least one TCI state further indicates whether to re-establish a radio link control (RLC) or not.

34. The terminal of claim 29, wherein the information indicating the activated at least one TCI state further indicates whether to reset a medium access control (MAC) or not.

35. The terminal of claim 29, wherein the first cell and the second cell are associated with the same security key.
